(19) United States
(12) Patent Application Publication
(10) Pub. No.: US 2026/0100481 A1
(43) Pub. Date: Apr. 9, 2026

(54) COMPOSITE SEPARATOR, COMPOSITE ELECTROLYTE INCLUDING THE SAME, AND LITHIUM BATTERY INCLUDING THE SAME

(71) Applicant: The Industry & Academic Cooperation in Chungnam National University (IAC), Daejeon (KR)

(72) Inventors: Heesu KIM, Daejeon (KR); Youngmin Moon, Daejeon (KR); Sangbaek Park, Daejeon (KR); Woo-Jin Song, Daejeon (KR); Seung-Wan Song, Daejeon (KR)

(73) Assignee: The Industry & Academic Cooperation in Chungnam National University (IAC), Daejeon (KR)

(21) Appl. No.: 19/336,693

(22) Filed: Sep. 23, 2025

(30) Foreign Application Priority Data
Oct. 4, 2024 (KR) 10-2024-0135053
Jul. 14, 2025 (KR) 10-2025-0094734
Sep. 16, 2025 (KR) 10-2025-0132836

(51) Int. Cl. H01M 50/457; H01M 10/052; H01M 10/0562; H01M 50/423; H01M 50/426; H01M 50/491; H01M 50/497

(52) U.S. Cl. CPC H01M 50/457; H01M 10/052; H01M 10/0562; H01M 50/423; H01M 50/426; H01M 50/491; H01M 50/497; H01M 2300/0071

(57) ABSTRACT

Disclosed herein are a composite separator, a composite electrolyte including the composite separator, and a lithium battery including the composite separator, the composite separator including a first layer including an oxide-based solid electrolyte and a carbonyl group-containing a first polymer, a second layer disposed on one surface of the first layer and including a second polymer, and a third layer disposed on the other surface of the first layer and including a third polymer, wherein a content of the oxide-based solid electrolyte is 80 wt % or more with respect to a total weight of the oxide-based solid electrolyte and the first polymer.

### CROSS-REFERENCE TO RELATED APPLICATION

This application is based on and claims priority under 35 U.S.C. § 119 to Korean Patent Application Nos. 10-2024-0135053, filed on Oct. 4, 2024, 10-2025-0094734, filed on Jul. 14, 2025, and 10-2025-0132836, filed on Sep. 16, 2025, in the Korean Intellectual Property Office, the disclosures of which are incorporated by reference herein in its entirety.

### BACKGROUND

### 1. Field

The disclosure relates to a composite separator, a composite electrolyte including the same, and a lithium battery including the same.

### 2. Description of the Related Art

Recently, there has been active development of batteries that provide high energy density and safety. Lithium batteries are used in information devices, communication devices, automobiles, and the like. Safety is important in lithium batteries.

Lithium batteries employing liquid electrolytes have advantages such as high ionic conductivity and low interfacial resistance. Lithium batteries employing liquid electrolytes have a disadvantage of poor safety in that they have a high risk of fire and/or explosion in the event of a short circuit.

Lithium batteries employing solid electrolytes have disadvantages such as low ionic conductivity and high interfacial resistance. Lithium batteries employing solid electrolytes have an advantage of excellent safety in that they have a low risk of fire and/or explosion in the event of a short circuit.

### SUMMARY

An electrolyte including a solid electrolyte and a polymer has advantages of increased safety compared to a liquid electrolyte, reduced interfacial resistance compared to a solid electrolyte, and improved electrochemical stability compared to a solid electrolyte. An electrolyte including a solid electrolyte and a polymer has disadvantages such as difficulty in providing uniform mixing of the solid electrolyte and the polymer or deterioration due to side reactions between the solid electrolyte and the polymer.

There is required a composite electrolyte and/or composite separator that includes a uniform mixture of a solid electrolyte and a polymer, suppresses side reactions between the solid electrolyte and the polymer, and provides improved safety, reduced interfacial resistance, and improved electrochemical stability.

Provided is a novel composite separator having reduced interfacial resistance, improved mechanical properties, improved heat resistance and enhanced flame retardancy.

Provided is a composite electrolyte having reduced interfacial resistance and improved electrochemical stability.

Provided is a lithium battery having improved heat resistance, flame retardancy and lifespan characteristics.

Additional aspects will be set forth in part in the description which follows and, in part, will be apparent from the description, or may be learned by practice of the presented embodiments of the disclosure.

According to an aspect of the disclosure, a composite separator includes a first layer including an oxide-based solid electrolyte and a carbonyl group-containing first polymer, a second layer disposed on one surface of the first layer and including a second polymer, and a third layer disposed on the other surface of the first layer and including a third polymer, wherein a content of the oxide-based solid electrolyte is 80 wt % or more with respect to a total weight of the oxide-based solid electrolyte and the first polymer.

According to another aspect of the disclosure, a composite electrolyte includes the composite separator, and an electrolyte disposed in the composite separator.

According to another aspect of the disclosure, a lithium battery includes a cathode, an anode, and the composite separator between the cathode and the anode.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic cross-sectional view of a composite separator according to an embodiment;

FIG. 2 is a schematic cross-sectional view of a composite separator according to another embodiment;

FIG. 3 is a schematic cross-sectional view of an oxide-based solid electrolyte according to an embodiment;

FIG. 4 is a schematic view of a lithium battery according to an embodiment;

FIG. 5 is a schematic view of a lithium battery according to an embodiment;

FIG. 6 is a schematic view of a lithium battery according to an embodiment;

FIG. 7 is a schematic view of a lithium battery according to an embodiment;

FIG. 8 shows XRD spectra of oxide-based solid electrolytes prepared in Preparation Examples 1 to 6;

FIG. 9A shows a scanning electron microscope image of a cross-section of a composite separator prepared in Example 1;

FIG. 9B shows an EDS mapping image of carbon on a cross-section of a composite separator prepared in Example 1;

FIG. 9C shows an EDS mapping image of nitrogen on a cross-section of a composite separator prepared in Example 1;

FIG. 9D shows an EDS mapping image of lanthanum on a cross-section of a composite separator prepared in Example 1;

FIG. 10A shows an image of stretched composite separator prepared in Example 1;

FIG. 10B shows an image of bended composite separator prepared in Example 1;

FIGS. 11A to 11E show transmission electron microscope images of LLZO solid electrolyte particles prepared in Preparation Example 1;

FIG. 12A to 12E show transmission electron microscope images of LLZO solid electrolyte particles prepared in Preparation Example 6;

FIGS. 13A to 13C show XPS depth profile measurement results for a surface of LLZO solid electrolyte particles prepared in Preparation Example 1;

FIGS. 14A to 14C show XPS depth profile measurement results for a surface of LLZO solid electrolyte particles prepared in Preparation Example 6;

FIGS. 15A to 15D show FT-IR spectra for a LLZO solid electrolyte prepared in Preparation Example 1, an ethylene-vinyl acetate (EVA) polymer used in Preparation Example 7, and ion-conducting composite membranes prepared in Preparation Examples 7 and 8;

FIG. 16 shows images of the evaluation results for thermal stability of separators of Comparative Example 1 and Preparation Example 7;

FIG. 17 shows images of the evaluation results for flame retardancy of separators of Comparative Example 1, Comparative Example 2, and Example 1;

FIG. 18 shows images of the evaluation results for flame retardancy of separators of Comparative Example 1, Comparative Example 2, and Example 1;

FIG. 19 is a graph showing the measurement results for Linear Sweep Voltammetry of separators of Comparative Example 1, Comparative Example 2, and Example 1;

FIG. 20 is a thermogravimetric analysis graph of a separator (Celgard) of Comparative Example 1, polyvinylidene fluoride (PVDF), polyethylene oxide (PEO), and ethylene-vinyl acetate (EVA) used in Preparation Example 7;

FIG. 21 shows the measurement results for porosity of separators of Comparative Example 1, Comparative Example 2, Preparation Example 7, and Example 1;

FIG. 22 shows the measurement results of electrolyte uptake of separators of Comparative Example 1, Comparative Example 2, Preparation Example 7, and Example 1;

FIG. 23 shows the measurement results for critical current of separators of Comparative Example 1, Comparative Example 2, Preparation Example 7, and Example 1;

FIG. 24 shows the measurement results for lifespan characteristics of separators of Comparative Example 1, Comparative Example 2, Preparation Example 7, and Example 1;

FIG. 25 is a graph showing the results of charge/discharge characteristics of lithium batteries of Example 3 and Comparative Example 3; and

FIG. 26 is a graph showing the results of charge/discharge characteristics of a lithium battery of Example 4.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Unless otherwise defined, all terms (including technical and scientific terms) used in this disclosure have the same meaning as commonly understood by one of ordinary skill in the art to which this disclosure belongs. It will also be understood that terms defined in commonly used dictionaries should be interpreted as having a meaning consistent with their meaning within the context of the relevant art and the present disclosure, and not in an idealized or overly formal sense.

Exemplary embodiments are described herein with reference to cross-sectional views which are schematic views of idealized embodiments. In this way, for example, variations from the shapes of the drawings may be expected as a result of manufacturing techniques and/or tolerances. Therefore, the embodiments described herein should not be construed as being limited to the specific shapes of regions as illustrated in the drawings of this disclosure, and should include, for example, deviations in shapes resulting from manufacturing. For example, a region illustrated or described as flat may typically have rough and/or non-linear features. Further, sharply illustrated angles may be round. Accordingly, the regions illustrated in the drawings are schematic in nature, and their shapes are not intended to illustrate the precise shape of the regions and are not intended to limit the scope of this disclosure.

The present inventive concept may be embodied in many different forms and should not be construed as limited to the embodiments described in this disclosure. Embodiments are provided so that this disclosure will be made thoroughly and completely, and will fully transfer the scope of the present inventive concept to those skilled in the art. In this disclosure, identical reference numerals refer to identical components.

When a component is referred to as being “over” another component, it can be understood that it may be directly on another component, or that there may be other components intervening therebetween. In contrast, when a component is said to be “directly on” another component, there are no intervening component therebetween.

The terms “first,” “second,” “third,” etc. may be used herein to describe various components, ingredients, regions, layers, and/or zones, these components, ingredients, regions, layers, and/or zones should not be limited by these terms. These terms are used only to distinguish one component, ingredient, region, layer or zone from another component, ingredient, region, layer or zone. Accordingly, a first component, ingredient, region, layer or zone described below may be referred to as a second component, ingredient, region, layer or zone without departing from the teachings of the present disclosure.

The terms used in this disclosure is for the purpose of describing specific embodiments only and is not intended to limit the present inventive concept. As used herein, the singular form is intended to include the plural form including “at least one” unless the context clearly dictates otherwise. “At least one” should not be construed as limiting to the singular. As used herein, the term “and/or” includes any and all combinations of one or more of the listed items. The terms “include” and/or “including” as used in the detailed description specify stated features, regions, integers, steps, operations, components and/or ingredients, but do not preclude the presence or addition of one or more other features, regions, integers, steps, operations, components and/or ingredients.

Spatially relative terms such as “bottom,” “below,” “lower,” “upper,” “top,” and the like may be used herein to easily describe the relationship of one component or feature to another component or feature. It will be understood that spatially relative terms are intended to include different directions of a device when used or operated in addition to the directions illustrated in the drawings. For example, if the device in the drawing is overturned, a component described as being “under” or “below” another component or feature would be oriented “above” the other component or feature. Thus, the exemplary term “below” may include both upward and downward directions. The above device may be placed in other directions (rotated 90 degrees or in other directions), and the spatially relative terms used herein may be interpreted accordingly.

As used herein, the “group” refers to a group of the periodic table of elements according to the International Union of Pure and Applied Chemistry (“IUPAC”) Group 1 to 18 classification system.

In this disclosure, the “particle size” refers to an average diameter when a particle is spherical, and refers to an average major axis length when the particle is non-spherical. The particle size may be measured using a particle size analyzer (PSA). The “particle size” is, for example, an average particle size. The “average particle size” is, for example, a median particle diameter, D50.

D50 is a size of the particle corresponding to 50% of the cumulative volume, calculated from the side of the particle with the smaller particle size in the size distribution of the particles measured by laser diffraction.

D90 is a size of the particle corresponding to 90% of the cumulative volume, calculated from the side of the particle with the smaller particle size in the size distribution of the particles measured by laser diffraction.

D10 is a size of the particle corresponding to 10% of the cumulative volume, calculated from the side of the particle with the smaller particle size in the size distribution of the particles measured by laser diffraction.

As used herein, the “metal” includes both metals and metalloids such as silicon and germanium, in either an elemental or ionic state.

As used herein, the “alloy” refers to a mixture of two or more metals.

As used herein, the “electrode active material” refers to an electrode material capable of undergoing lithiation and delithiation.

As used herein, the “cathode active material” refers to a cathode material capable of undergoing lithiation and delithiation.

As used herein, the “anode active material” refers to an anode material capable of undergoing lithiation and delithiation.

As used herein, the “lithiation” and “lithiating” refer to a process of adding lithium to an electrode active material.

As used herein, the “delithiation” and “delithiating” refer to a process of removing lithium from an electrode active material.

As used herein, the “charge” and “charging” refer to a process of providing electrochemical energy to a battery.

As used herein, the “discharge” and “discharging” refer to a process of removing electrochemical energy from a battery.

As used herein, the “positive electrode” or “cathode” refers to an electrode where electrochemical reduction and lithiation occur during a discharge process.

As used herein, the “negative electrode” or “anode” refers to an electrode where electrochemical oxidation and delithiation occur during a discharge process.

Although specific embodiments have been described, alternatives, modifications, variations, improvements, and substantial equivalents, which are not currently anticipated or cannot be anticipated, may occur to the applicant or those skilled in the art. Accordingly, the appended claims, as filed and as amended, are intended to include all such alternatives, modifications, variations, improvements and substantial equivalents.

Hereinafter, a composite separator, a composite electrolyte including the composite separator, and a lithium battery including the composite separator according to embodiments will be described in more detail.

### [Composite Separator]

A composite separator according to an embodiment includes a first layer including an oxide-based solid electrolyte and a carbonyl group-containing first polymer. The composite separator includes a second layer disposed on one surface of the first layer and including a second polymer. The composite separator includes a third layer disposed on the other surface of the first layer and including a third polymer. The content of the oxide-based solid electrolyte is 80 wt % or more with respect to the total weight of the oxide-based solid electrolyte and the first polymer.

Since the composite separator includes the first layer including an oxide-based solid electrolyte of 80 wt % or more and the first polymer containing a carbonyl group, it can provide reduced interfacial resistance, improved mechanical properties, improved heat resistance, and improved flame retardancy.

Since the first layer includes the carbonyl group-containing first polymer having high binding force to the oxide-based solid electrolyte, uniform mixing of the oxide-based solid electrolyte and the first polymer can be easily achieved, and the mechanical properties of the first layer, for example, an ion-conductive composite layer, can be improved. As a result, the structural stability of the composite separator can be improved. In contrast, since a polymer containing an alkylene oxide repeating unit has low binding force to the oxide-based solid electrolyte, uniform mixing of the oxide-based solid electrolyte and the polymer containing an alkylene oxide repeating unit may be difficult. As a result, the mechanical properties of the first layer, for example, ion-conductive composite layer including a polymer including an alkylene oxide repeating unit may be deteriorated. As a result, the structural stability of the composite separator may be deteriorated. A fluorine-containing polymer may cause a side reaction with a lithium-containing compound remaining in an oxide-based solid electrolyte, thereby accelerating the deterioration of the first layer, for example, an ion-conductive composite layer and a composite separator including the first layer, such as deterioration of interface stability, deterioration of ionic conductivity, and deterioration of mechanical properties.

In the first layer, the content of the oxide-based solid electrolyte with respect to the total weight of the oxide-based solid electrolyte and the first polymer may be, for example, 80 wt % or more, 81 wt % or more, 85 wt % or more, 90 wt % or more, 92 wt % or more, 95 wt % or more, or 97 wt % or more. In the first layer, the content of the oxide-based solid electrolyte with respect to the total weight of the oxide-based solid electrolyte and the first polymer may be, for example, about 80 wt % to about 99 wt %, about 85 wt % to about 99 wt %, about 90 wt % to about 99 wt %, about 92 wt % to about 99 wt %, about 95 wt % to about 99 wt %, or about 97 wt % to about 99 wt %. Since the first layer includes an oxide-based solid electrolyte within this range, the content of an organic component such as the first polymer is reduced, so that the mechanical properties, thermal stability, and flame retardancy of the first layer and the composite separator including the first layer can be further improved. Additionally, since the interfacial resistance of the first layer is reduced, the ionic conductivity of the first layer and the composite separator including the first layer can be improved.

Since a second layer including a second polymer and a third layer including a third polymer are added to both surfaces of the first layer, the structural stability of the composite separator can be further improved. The composite separator may more easily accommodate volume changes during the charging and discharging of a lithium battery. Since the composite separator more easily adheres to the surfaces of a cathode and an anode, an increase in internal resistance of a lithium battery including the composite separator can be more effectively suppressed during the charging and discharging of the lithium battery.

Since the composite separator includes a first layer and second and third layers disposed on both surfaces of the first layer, reduced interfacial resistance, improved mechanical properties, improved heat resistance and improved flame retardancy can be provided.

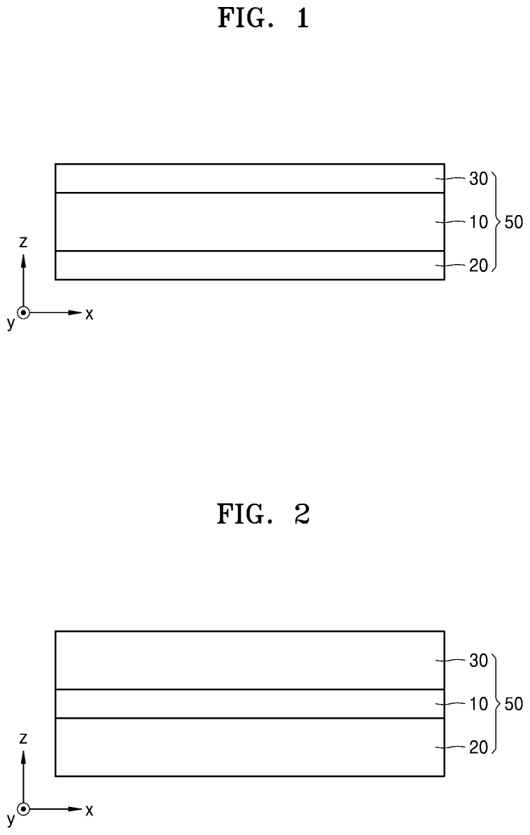

FIGS. 1 and 2 are schematic cross-sectional views of a composite separator according to an embodiment.

Referring to FIGS. 1 and 2, a composite separator 50 includes a first layer 10, a second layer 20 on one surface of the first layer 10, and a third layer 30 on the other surface of the first layer 10 opposite to the one surface thereof.

The first layer 10 includes an oxide-based solid electrolyte and a carbonyl group-containing first polymer. The second layer 20 includes a second polymer, and the third layer 30 includes a third polymer.

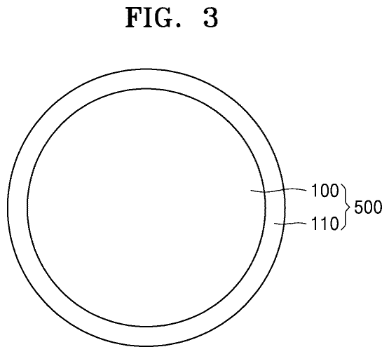

FIG. 3 is a schematic cross-sectional view of an oxide-based solid electrolyte according to an embodiment.

Referring to FIG. 3, an oxide-based solid electrolyte 500 may include an oxide-based solid electrolyte core 100 and a coating layer 110 disposed on the surface of the core 100.

Since the oxide-based solid electrolyte 500 includes the coating layer 110, the binding force between the first polymer and the oxide-based solid electrolyte 500 may increase. As a result, the mechanical properties of the first layer 10 including the oxide-based solid electrolyte 500 and the first polymer and the composite separator 50 including the first layer 10 can be further improved.

The coating layer 110 may include, for example, a lithium-containing compound. The lithium-containing compound may include, for example, lithium carbonate (Li₂CO₃), lithium hydroxide (LiOH), or a combination thereof.

The coating layer 110 may be disposed, for example, between the oxide-based solid electrolyte core 100 and the first polymer. The oxide-based solid electrolyte core 100 may be spaced apart from the first polymer by the coating layer 110. The first polymer may be bound to the coating layer 110, and may thus be bound to the oxide-based solid electrolyte 500. The coating layer 110 may be, for example, a conformal coating layer disposed along a contour of the surface of the oxide-based solid electrolyte core 100. In addition, the first polymer may be bonded along a contour of the surface of the coating layer 110. Since the oxide-based solid electrolyte 500 includes the conformal coating layer 110, the contact area between the oxide-based solid electrolyte 500 and the first polymer may be further increased.

In the XPS depth profile measurement of the surface of the oxide-based solid electrolyte 500, for example, a second oxygen peak derived from lattice oxygen (O_{lattice}) of the oxide-based solid electrolyte at a binding energy of about 527.5 eV to about 530 eV may be absent (free) at the beginning of ion sputtering In the XPS depth profile measurement of the surface of the oxide-based solid electrolyte 500, for example, the oxide-based solid electrolyte core 100 may not be exposed to the surface of the oxide-based solid electrolyte 500 because the oxide-based solid electrolyte core 100 is completely covered by the coating layer 110 at the beginning of ion sputtering. Thus, the second oxygen peak derived from the oxide-based solid electrolyte core 100 may be absent (free).

In the XPS depth profile measurement of the surface of the oxide-based solid electrolyte 500, for example, after 130 seconds, 260 seconds, 390 seconds, 520 seconds, or 650 seconds from the beginning of ion sputtering, the ratio (P2/P1) of the intensity (P1) of the first oxygen peak derived from lithium carbonate (Li₂CO₃) at a binding energy of about 530 eV to about 532.5 eV and the intensity (P2) of the second oxygen peak derived from lattice oxygen (O_{lattice}) of the oxide-based solid electrolyte at a binding energy of about 527.5 eV to about 530 eV may be 1 or less. Ion sputtering may be performed, for example, using an Ar⁺ ion beam. The energy range of ion sputtering was, for example, about 100 eV to about 4 keV, and the maximum ion beam current was, for example, 4 μA at 3 keV.

In the XPS depth profile measurement of the surface of the oxide-based solid electrolyte 500, for example, after etching is performed in a depth direction for 130 seconds, 260 seconds, 390 seconds, 520 seconds, or 650 seconds from the beginning of ion sputtering, the oxide-based solid electrolyte core 100 is covered by the coating layer 110, so that the ratio (P2/P1) of the intensity (P1) of the first oxygen peak derived from lithium carbonate (Li₂CO₃) and the intensity (P2) of the second oxygen peak derived from lattice oxygen (O_{lattice}) of the oxide-based solid electrolyte at a binding energy of about 527.5 eV to about 530 eV may be 1 or less. The thick coating layer 110 may be disposed on the oxide-based solid electrolyte core 100.

In the XPS depth profile measurement of the surface of the oxide-based solid electrolyte 500, for example, even when etching is performed in the depth direction for 130 seconds to 780 seconds, 260 seconds to 780 seconds, 390 seconds to 780 seconds, 520 seconds to 780 seconds, or 650 seconds to 780 seconds from the beginning of ion sputtering, the oxide-based solid electrolyte core 100 is covered by the coating layer 110, so that the ratio (P2/P1) of the intensity (P1) of the first oxygen peak derived from lithium carbonate (Li₂CO₃) and the intensity (P2) of the second oxygen peak derived from lattice oxygen (O_{lattice}) of the oxide-based solid electrolyte at a binding energy of about 527.5 eV to about 530 eV may be 1 or less. The thick coating layer 110 may be disposed on the oxide-based solid electrolyte core 100.

In the XPS depth profile measurement of the surface of the oxide-based solid electrolyte 500, for example, after 130 seconds, 260 seconds, 390 seconds, 520 seconds, or 650 seconds from the beginning of ion sputtering, the intensity (P1) of the first oxygen peak derived from the lithium carbonate-containing coating layer may be greater than the intensity (P2) of the second oxygen peak derived from the lattice oxygen of the oxide-based solid electrolyte.

In the XPS depth profile measurement of the surface of the oxide-based solid electrolyte 500, for example, for 130 seconds to 780 seconds, 260 seconds to 780 seconds, 390 seconds to 780 seconds, 520 seconds to 780 seconds, or 650 seconds to 780 seconds from the beginning of ion sputtering, the intensity (P1) of the first oxygen peak derived from the lithium carbonate-containing coating layer may be greater than the intensity (P2) of the second oxygen peak derived from the lattice oxygen of the oxide-based solid electrolyte.

Since the oxide-based solid electrolyte 500 includes this thick coating layer 110, the carbonyl group-containing first binder may be more strongly bound to the oxide-based solid electrolyte 500.

The thickness of the coating layer 110 may be, for example, about 3 nm to about 100 nm, about 5 nm to about 50 nm, about 10 nm to about 40 nm, about 15 nm to about 35 nm, or about 20 nm to about 30 nm. Since the coating layer 110 has a thickness in this range, the binding between the oxide-based solid electrolyte 500 and the first polymer may be maintained more firmly. As a result, the mechanical properties of the first layer 10 including the oxide-based solid electrolyte 500 and the first polymer and the composite separator 50 including the same can be further improved.

When the thickness of the coating layer 110 is too small, the binding force between the oxide-based solid electrolyte and the first polymer may be relatively reduced. When the thickness of the coating layer 110 is too large, the overall ionic conductivity of the composite separator may decrease due to an excessive increase in the content of lithium carbonate. The thickness of the coating layer 110 may be measured by a scanning electron microscope (SEM), a transmission electron microscope (TEM), or the like.

The oxide-based solid electrolyte 500 may be an oxide or phosphate including lithium and two or more metals other than lithium

The oxide-based solid electrolyte 500 may be, for example, a crystalline solid electrolyte or an amorphous solid electrolyte.

The oxide-based solid electrolyte 500 may include, for example, a Garnet-type solid electrolyte, a NASICON-type solid electrolyte, a LISICON-type solid electrolyte, a perovskite-type solid electrolyte, a LiPON-type solid electrolyte, an amorphous solid electrolyte, or a combination thereof.

The garnet-type solid electrolyte may include lithium lanthanum zirconium oxide (LLZO) represented by Li₃₊ₓLa_{y}M_{z}O₁₂ (1≤x≤10, 2≤y≤4, 1≤c≤3, M is Zr, Ga, W, Nb, Ta, Al, or a combination thereof). The garnet-type solid electrolyte may include, for example, Li₇La₃Zr₂O₁₂, Li₃₊ₓLa₃Zr₂₋ₐMₐO₁₂ (M doped LLZO, M=Ga, W, Nb, Ta, Al or a combination thereof, 1≤x≤10, 0<a<2), or the like.

The NASICON-type solid electrolyte may include, for example, lithium-aluminum-transition metal-phosphate (LAMP) represented by Li₁₊ₓAlₓM₂₋ₓ(PO₄)₃ (0<X<2, M is Zr, Ti, Ge, or a combination thereof). The NASICON-type solid electrolyte may include, for example, lithium-aluminum-titanium-phosphate (LATP) such as Li₁₊ₓAlₓTi₂₋ₓ(PO₄)₃ (0<x<1) in which Ti is introduced as a transition metal, Li_{1.3}Al_{0.3}Ti_{1.7}(PO₄)₃ in which excess lithium is introduced, lithium-aluminum-germanium-phosphate (LAGP) represented by Li₁₊ₓAlₓGe₂₋ₓ(PO₄)₃ (0<x<1), lithium-zirconium-phosphate (LZP) represented by LiZr₂(PO₄)₃, or the like.

The LISICON-type solid electrolyte may be represented, for example, by xLi₃AO₄-(1−x)Li₄BO₄ (A is P, As, or V, and B is Si, Ge, or Ti). The LISICON-type solid electrolyte may include a solid solution oxide, for example, Li₄Zn(GeO₄)₄, Li₁₀GeP₂O₁₂ (LGPO), Li_{3.5}Si_{0.5}P_{0.5}O₄, Li_{10.42}Si(Ge)_{1.5}P_{1.5}Cl_{0.08}O_{11.92}, or the like.

The perovskite-type solid electrolyte may include a lithium-lanthanum-titanium-oxide (LLTO) represented by Li₃ₓLa_{2/3-x1/3-2x}TiO₃ (0<x<0.16). The perovskite-type solid electrolyte may include, for example, Li_{1/8}La_{5/8}TiO₃.

The LIPON-type solid electrolyte may include lithium phosphorous oxynitride (LIPON). The LIPON-type solid electrolyte may include a nitride such as Li_{2.8}PO_{3.3}N_{0.46}.

The amorphous solid electrolyte may include Li₂O—B₂O₃—SiO₂, Li₂—O—B₂O₃—P₂O₅, Li₃BO₃—Li₂SO₄, or Li₃BO₃—Li₂CO₃.

The oxide-based solid electrolyte 500 may include, for example, Li_{1+x+y}AlₓTi₂₋ₓSi_{y}P_{3-y}O₁₂ (0<x<2, 0≤y<3), LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(Al, Ga)ₓ(Ti, Ge)₂₋ₓSi_{y}P_{3-y}O₁₂ (0≤x≤1, 0≤y≤1), LiₓLa_{y}TiO₃ (0<x<2, 0<y<3), Li₂O—Al₂O₃—SiO₂—P₂O₅—TiO₂—GeO₂, Li₃₊ₓLa₃M₂O₁₂ (M=Te, Nb, or Zr, x is an integer of 1 to 10), or the like.

The oxide-based solid electrolyte 500 may include a lithium-lanthanum-zirconium-oxide (LLZO), a lithium-aluminum-titanium-phosphate (LATP), a lithium-lanthanum-titanium-oxide (LLTO), a lithium-aluminum-germanium-phosphate (LAGP), or a combination thereof.

In the lithium-lanthanum-zirconium-oxide (LLZO), for example, the content of lithium per mole of the lithium-lanthanum-zirconium-oxide may be 6.8 mol or more, 6.85 mol or more, 6.90 mol or more, 6.97 mol or more, or 7.0 mol or more.

In the lithium-lanthanum-zirconium-oxide (LLZO), for example, the content of lithium per mole of the lithium-lanthanum-zirconium-oxide may be about 6.8 mol to about 10 mol, about 6.85 mol to about 9 mol, about 6.90 mol to about 8 mol, about 6.97 mol to about 8 mol, or about 7.0 mol to about 8 mol.

Since the lithium-lanthanum-zirconium-oxide (LLZO) has such a high lithium content, the ionic conductivity of an ion-conductive composite film including the lithium-lanthanum-zirconium-oxide (LLZO) and a composite separator including the same can be further improved. In addition, since the binding force between the lithium-lanthanum-zirconium-oxide (LLZO) and the first polymer increases, the mechanical properties of an ion-conductive composite film and a composite separator including the same can be further improved. The content of lithium in the lithium-lanthanum-zirconium-oxide (LLZO) may be measured, for example, by inductively coupled plasma atomic emission spectrometry (ICP-AES).

The oxide-based solid electrolyte 500 may include, for example, a garnet-type oxide. The garnet-type oxide may include, for example, a cubic phase. The garnet-type oxide can provide improved ionic conductivity by including a cubic phase.

The garnet-type oxide may be represented by Formula 1 below:

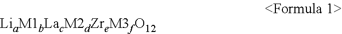

in the formula,
M1 is H, Fe, Ga, Al, B, Be, or a combination thereof,
M2 is Ba, Ca, Sr, Y, Bi, Pr, Nd, Ac, Sm, Gd, or a combination thereof,
M3 is Al, Ga, Ta, Nb, Hf, Ti, V, Cr, Co, Ni, Cu, Mo, W, Mg, Tc, Ru, Pd, Sc, Cd, In, Sb, Te, TI, Pt, Si, Ir, Mn, Sn, or a combination thereof, and

6≤a≤8, 0≤b≤2, 2.5≤c≤3.5, 0≤d<0.2, 1.5≤e≤2.5, and 0≤f≤1.

In the formula, for example, 6.1≤a≤8, 6.2≤a≤8, 6.3≤a≤8, 6.4≤a≤8, 6.5≤a≤8, 6.6≤a≤8, 6.7≤a≤8, 6.8≤a≤8, 6.9≤a≤8 or 7.0≤a≤8.

In the formula, for example, 2.5≤c≤3.5, 2.8≤c≤3.2 or 2.9≤c≤3.1.

In the formula, for example, 1.5≤e≤2.5, 1.8≤e≤2.2 or 1.8≤e≤2.0.

The oxide-based solid electrolyte 500 may have, for example, a particle form. The oxide-based solid electrolyte 500 may include, for example, oxide-based solid electrolyte particles. The particle size of the oxide-based solid electrolyte 500 may be, for example, about 1 μm to about 50 μm, about 1 μm to about 40 μm, about 1 μm to about 30 μm, about 1 μm to about 20 μm, or about 1 μm to about 10 μm. Since the oxide-based solid electrolyte 500 has a particle size within this range, the oxide-based solid electrolyte 500 may be more firmly bound to the first polymer.

The particle size of the oxide-based solid electrolyte 500 may be, for example, an arithmetic average of particle sizes of particles calculated using software from scanning electron microscope images or calculated manually. Alternatively, the particle size of the oxide-based solid electrolyte 500 may be measured using a particle size analyzer (PSA) by laser diffraction.

Referring to FIGS. 1 and 2, the composite separator 50 includes the first layer 10, and the first layer 10 includes an oxide-based solid electrolyte and a carbonyl group-containing first polymer.

The carbonyl group-containing first polymer may include, for example, an ester group-containing polymer, an amide group-containing polymer, or a combination thereof. The ester group and the amide group contain a carbonyl group within the molecular structure thereof.

Since the first polymer includes such a polymer, the first polymer is firmly bound to the oxide-based solid electrolyte, so that the mechanical properties of the first layer 10 including the first polymer and the composite separator 50 including the first layer 10 can be improved.

The first polymer may be, for example, a non-fluorinated polymer. The first polymer may not contain a fluorine atom. Since the first polymer is a non-fluorinated polymer, a lithium salt, moisture, or the like may be generated by a side reaction between fluorine and a lithium-containing compound. Due to such a side reaction, the interface stability of the composite separator 50 may be lowered, the ionic conductivity thereof may be lowered, and the mechanical properties thereof may be deteriorated.

The first polymer may be, for example, a non-ether group-containing polymer. The first polymer may not contain an ether group. The non-ether group-containing polymer may be, for example, a non-alkylene oxide group-containing polymer. The first polymer may not contain an alkylene oxide group such as an ethylene oxide group.

Since the alkylene oxide group-containing polymer has a weak binding force with the oxide-based solid electrolyte, the mechanical properties of the first layer 10 including the alkylene oxide group-containing polymer and the composite separator 50 including the first layer 10 can be improved.

The first polymer may include, for example, an acetate polymer, an acrylic polymer, a urethane polymer, or a combination thereof. The first polymer may include, for example, ethylene-vinyl acetate (EVA), polyvinyl acetate (PVAc), polyurethane (PU), polymethyl methacrylate (PMMA), polyethylene terephthalate (PET), or a combination thereof. The first polymer may be, for example, a copolymer. Since the first polymer is a copolymer, it can provide improved physical properties. The thermal decomposition temperature of the first polymer during TGA thermal analysis may be, for example, 300° C. or higher, 330° C. or higher, or 350° C. or higher. Since the first polymer has such a high thermal decomposition temperature, the first layer 10 including the first polymer and the composite separator 50 including the first layer 10 can provide improved thermal stability.

The first layer 10 may include, for example, an ion-conductive composite film. The oxide-based solid electrolyte having ionic conductivity and the first polymer may be uniformly mixed and bonded to form an ion-conductive composite film.

The ion-conductive composite film may be, for example, a free-standing film. Since the ion-conductive composite film is a free-standing film, the handling of the ion-conductive composite film may be facilitated. For example, the manufacture of the composite separator 50 including the first layer 10 prepared from an ion-conductive composite membrane, which is a free-standing film, may be performed more easily.

The ion-conductive composite film 10 may be, for example, a flexible free-standing film. Since the ion-conductive composite film 10 is a flexible self-standing film, the composite separator 50 including the ion-conductive composite film 10 may be a flexible free-standing film. Therefore, the composite separator 50 may be easily applied to batteries of various structures.

The composite separator 50 may be a stretchable free-standing film. Since the second layer 20 including a second polymer and the third layer 30 including a third layer are disposed on the first layer 10, which is a flexible free-standing film, the composite separator 50 may have stretchability. Therefore, the composite separator 50 may easily accommodate a volume change during the charging and discharging of a lithium battery.

Referring to FIGS. 1 and 2, the composite separator 50 includes a second layer 20 including a first polymer and a third layer 30 including a second polymer.

The second layer 20 and/or the third layer 30 may be, for example, a porous layer. Since the second layer 20 and/or the third layer 30 is a porous layer, the structural flexibility of the composite separator 50 can be improved.

The second polymer and the third polymer may each independently be a fluorine-based polymer. The second polymer and/or the third polymer may have a structure in which some or all of hydrogen atoms in the polymer are substituted with fluorine atoms.

The second polymer and the third polymer may each independently include, for example, polyvinylidene fluoride (PVDF), polyvinylidene fluoride-hexafluoropropylene copolymer (PVDF-HFP), polytetrafluoroethylene (PTFE), or a combination thereof. Since the second polymer and/or the third polymer includes such a fluorine-based polymer, the flame retardancy of the composite separator 50 can be further improved.

At least one of the second layer 20 including the second polymer and the third layer 30 including the third polymer may be an organic layer made of, for example, an organic material. Since at least one of the second layer 20 and the third layer 30 is an organic layer, the composite separator 50 may more easily accommodate a volume change of a lithium battery.

In at least one of the second layer 20 including the second polymer and the third layer 30 including the third polymer, for example, inorganic particles may be absent (free). At least one of the second layer 20 and the third layer 30 may not include inorganic particles, such as metal particles, metal oxide particles, oxide-based solid electrolyte particles, or sulfide-based solid electrolyte particles.

Referring to FIGS. 1 and 2, the composite separator 50 includes the first layer 10, the second layer 20, and the third layer 30, and the ratio (T2/T1) of the thickness (T2) of the second layer to the thickness (T1) of the first layer may be about 0.01 to about 100, about 0.05 to about 50, about 0.1 to about 10, about 0.5 to about 5, about 0.5 to about 2, or about 0.5 to about 1.5. Since the ratio (T2/T1) of the thickness (T2) of the second layer to the thickness (T1) of the first layer is within this range, the structural stability of the composite separator 50 can be further improved.

Referring to FIGS. 1 and 2, the composite separator 50 includes the first layer 10, the second layer 20, and the third layer 30, and the ratio (T3/T1) of the thickness (T3) of the third layer to the thickness (T1) of the first layer may be about 0.01 to about 100, about 0.05 to about 50, about 0.1 to about 10, about 0.5 to about 5, about 0.5 to about 2, or about 0.5 to about 1.5. Since the ratio (T3/T1) of the thickness (T3) of the third layer to the thickness (T1) of the first layer is within this range, the structural stability of the composite separator 50 can be further improved.

Referring to FIG. 1, the composite separator 50 includes the first layer 10 and the second layer 20, and the ratio (T2/T1) of the thickness (T2) of the second layer 20 to the thickness (T1) of the first layer may be 1 or less, 0.9 or less, 0.8 or less, 0.5 or less, 0.3 or less, or 0.1 or less. Since the ratio (T2/T1) of the thickness (T2) of the second layer 20 to the thickness (T1) of the first layer 10 is within this range, the mechanical properties of the composite separator 50 can be further improved.

Referring to FIG. 1, the composite separator 50 includes the first layer 10 and the third layer 30, and the ratio (T3/T1) of the thickness (T3) of the third layer 30 to the thickness (T1) of the first layer may be 1 or less, 0.9 or less, 0.8 or less, 0.5 or less, 0.3 or less, or 0.1 or less. Since the ratio (T3/T1) of the thickness (T3) of the third layer 30 to the thickness (T1) of the first layer 10 is within this range, the mechanical properties of the composite separator 50 can be further improved.

Referring to FIG. 2, the composite separator 50 includes the first layer 10 and the second layer 20, and the ratio (T2/T1) of the thickness (T2) of the second layer 20 to the thickness (T1) of the first layer 10 may be more than 1, 1.5 or more, 2 or more, 5 or more, or 10 or more. Since the ratio (T2/T1) of the thickness (T2) of the second layer 20 to the thickness (T1) of the first layer 10 is within this range, the flexibility and/or stretchability of the composite separator (50) can be further improved.

Referring to FIG. 2, the composite separator 50 includes the first layer 10 and the third layer 30, and the ratio (T3/T1) of the thickness (T3) of the third layer 30 to the thickness (T1) of the first layer 10 may be more than 1, 1.5 or more, 2 or more, 5 or more, or 10 or more. Since the ratio (T3/T1) of the thickness (T3) of the third layer 30 to the thickness (T1) of the first layer 10 is within this range, the flexibility and/or stretchability of the composite separator (50) can be further improved.

The thickness of the first layer 10 may be, for example, about 10 μm to about 100 μm, about 10 μm to about 70 μm, or about 10 μm to about 50 μm. Since the thickness of the first layer 10 is within this range, the structural stability of the composite separator 50 can be further improved. The thickness of the second layer 20 and/or the third layer 30 may each independently be, for example, about 1 μm to about 100 μm, about 1 μm to about 50 μm, about 1 μm to about 20 μm, or about 1 μm to about 10 μm. Alternatively, the thickness of the second layer 20 and/or the third layer 30 may each independently be, for example, about 5 μm to about 100 μm, about 10 μm to about 100 μm, about 20 μm to about 100 μm, or about 50 μm to about 100 μm. Since the thickness of the second layer 20 and/or the third layer 30 is within this range, the structural stability of the composite separator 50 can be further improved. The thickness of the composite separator 50 may be, for example, about 30 μm to about 150 μm, about 50 μm to about 100 μm, or about 60 μm to about 80 μm. Since the composite separator 50 has a thickness within this range, it can provide both structural stability and flexibility.

Referring to FIGS. 1 and 2, the porosity of the first layer (10), that is, an ion-conductive composite layer, may be, for example, less than 30%, less than 25%, or less than 20%. Since the first layer 10 includes an oxide-based solid electrolyte and a carbonyl group-containing first polymer, it can provide excellent ionic conductivity despite having such low porosity.

The porosity of the second layer 20 and the third layer 30 may be, for example, more than 30%, 40% or more, or 50% or more. Since the second layer 20 and the third layer 30 each independently have high porosity within this range, for example, they may contain a liquid electrolyte more effectively and can provide increased ionic conductivity.

The porosity of the composite separator 50 may be, for example, 40% or less, 35% or less, 30% or less, or 25% or less. Since the composite separator 50 has the first layer 10 including an oxide-based solid electrolyte, the composite separator 50 may have such a low porosity.

The porosity of the first layer 10, the second layer 20, the third layer 30, and the composite separator 50 may be measured by a gas adsorption method. Alternatively, the porosity of the first layer 10, the second layer 20, the third layer 30, and the composite separator 50 may be calculated by measuring the volumes and weights of the first layer 10, the second layer 20, the third layer 30, and the composite separator 50, respectively, and considering the theoretical density of the materials constituting them. Alternatively, the porosity of the first layer 10, the second layer 20, the third layer 30, and the composite separator 50 may be measured by a liquid displacement method. Butanol may be used as a liquid. For example, the porosity of the first layer 10, the second layer 20, the third layer 30, and the composite separator 50 may be calculated by impregnating the first layer 10, the second layer 20, the third layer 30, and the composite separator 50 with liquid and then considering the density of the liquid and the separator from a difference in weight thereof.

The porosity may be calculated from Equation A below.

$$Porosity ( \% ) = {W}_{I} / {ρ}_{I} / ( WI / {ρ}_{I} + {W}_{s} / {ρ}_{s} ) \times 100 \qquad 〈 Equation A 〉$$

Wₗ is a weight of liquid, Wₛ is a weight of dry separator, ρᵢ is a density of liquid, and ρₛ is a density of separator.

Referring to FIGS. 1 and 2, the electrolyte uptake, i.e., electrolyte impregnation rate of the composite separator 50 may be, for example, 130% or less, 120% or less, 110% or less, or 100% or less. For example, the electrolyte absorption rate of the composite separator 50 may be calculated by impregnating the composite separator 50 with an electrolyte and then considering the density of the electrolyte from a difference in weight of the composite separator 50.

The electrolyte uptake may be calculated from Equation B below.

$$Electrolyte uptake ( \% ) = ( {W}_{wet} - {W}_{dry} ) / {W}_{dry} \times 100 \qquad 〈 Equation B 〉$$

W_{wet} is a weight of separator in which electrolyte is absorbed, and W_{dry} is a weight of dry separator. Despite the composite separator 50 having such a low electrolyte uptake, i.e., electrolyte impregnation rate, it can provide excellent ionic conductivity.

Referring to FIGS. 1 and 2, the composite separator 50 may have an ionic conductivity of, for example, 0.2 mS/cm or more, 0.3 mS/cm or more, 0.4 mS/cm or more, or 0.5 mS/cm or more at 25° C. and 1 atm.

Since the composite separator 50 has an ionic conductivity within this range, the charge/discharge characteristics of a lithium battery including the composite separator 50 can be further improved.

Referring to FIGS. 1 and 2, the composite separator 50 may have an effective ionic conductivity of, for example, 0.15 mS/cm or more, 0.2 mS/cm or more, 0.25 mS/cm or more, 0.3 mS/cm or more, 0.35 mS/cm or more, or 0.4 mS/cm or more at 25° C. and 1 atm. The effective ionic conductivity may be, for example, an ionic conductivity for lithium ions.

Since the composite separator 50 has an effective ionic conductivity within this range, the charge/discharge characteristics of a lithium battery including the composite separator 50 can be further improved.

Referring to FIGS. 1 and 2, the composite separator 50 may have a lithium ion transference number of, for example, 0.5 or more, 0.6 or more, 0.7 or more, or 0.8 or more at 25° C. and 1 atm.

The lithium ion transference number is a proportion of ionic conductivity by lithium ions in the total ionic conductivity.

Since the composite separator 50 has a high lithium ion transference number within this range, the charge/discharge characteristics of a lithium battery including the composite separator 50 can be further improved.

The ionic conductivity, effective ionic conductivity and lithium ion transference number of the composite separator may be measured by electrochemical impedance spectroscopy (EIS). Alternatively, the ionic conductivity, effective ionic conductivity and lithium ion transference number of the composite separator may be measured by a DC polarization method.

Referring to FIGS. 1 and 2, the electrochemically stable potential window having an oxidation current of 10 μA or less of the composite separator 50 may be, for example, 4.5 V (vs. Li) or more, 4.6 V (vs. Li) or more, or 4.7 V (vs. Li) or more. Since the composite separator 50 has such a wide range of electrochemically stable potential window, it may be easily applied to lithium batteries having various operating voltages. The method of measuring the potential window may be referred to Evaluation Example 8.

Referring to FIGS. 1 and 2, the composite separator 50 may have a heat shrinkage rate of, for example, 3% or less, 2% or less, or 1% or less after exposure at about 180° C. to about 200° C. for 20 minutes. Therefore, the composite separator 50 can provide improved thermal stability. The heat shrinkage ratio is a percentage of the area of the composite separator 50 after exposure to high temperature to the area of the composite separator 50 before exposure to high temperature. The method of measuring the thermal shrinkage rate may be referred to Evaluation Example 4. The composite separator 50 may have improved thermal stability by including the first layer 10 including an oxide-based solid electrolyte and a first polymer having excellent thermal stability.

Referring to FIGS. 1 and 2, the composite separator 50 may not undergo bending after exposure at about 120° C. to about 200° C. for 20 minutes. Therefore, the composite separator 50 can provide improved thermal stability. Whether or not the composite separator is bent is visually determined by whether the composite separator 50 in the form of a sheet before being exposed to high temperature is bent into the form of a tube after being exposed to high temperature. The method of measuring the bending may be referred to Evaluation Example 4. The composite separator 50 may have improved thermal stability by including the first layer 10 including an oxide-based solid electrolyte and a first polymer having excellent thermal stability.

Referring to FIGS. 1 and 2, the composite separator 50 may be self-extinguishing in which flame is extinguished in the composite separator 50 when the flame is removed after the composite separator 50 is exposed to the flame. Therefore, the composite separator 50 can provide improved flame retardancy. The method of measuring the self-extinguishing may be referred to Evaluation Example 5. The composite separator 50 may have improved thermal stability by including the first layer 10 including an oxide-based solid electrolyte and a first polymer having excellent thermal stability.

### [Composite Electrolyte]

A composite electrolyte according to another embodiment includes the above composite separator; and an electrolyte disposed in a first porous substrate of the composite separator.

The composite electrolyte can provide improved structural stability and excellent ionic conductivity by including the composite separator and the electrolyte in the first porous substrate.

The electrolyte disposed in the first porous substrate may be impregnated into the first porous substrate.

The electrolyte disposed in the first porous substrate may include, for example, a liquid electrolyte, a solid electrolyte, a gel electrolyte, or a combination thereof.

The liquid electrolyte includes, for example, an organic solvent and a lithium salt. Any organic solvent used in the relevant technical field may be used. The organic solvent may be, for example, propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethyl sulfoxide, dioxane, 1,2-dimethoxyethane, sulfolane, dichloroethane, chlorobenzene, nitrobenzene, diethylene glycol, dimethyl ether, or a mixture thereof. Any lithium salt used as a lithium salt in the relevant technical field may also be used. The lithium salt may be, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where x and y are natural numbers), LiCl, LiI, or a mixture thereof.

The solid electrolyte may include, for example, a polymer solid electrolyte.

The polymer solid electrolyte may include a mixture of a lithium salt and a polymer, or may include a polymer having an ion-conductive functional group. The polymer solid electrolyte may be, for example, a polymer electrolyte that is in a solid state at 25° C. and 1 atm. The polymer solid electrolyte may not include a liquid. The polymer electrolyte includes a polymer, and the polymer may be, but is not limited to, for example, polyethylene oxide (PEO), polyvinylidene fluoride (PVDF), vinylidene fluoride-hexafluoropropylene (PVDF-HFP), poly(styrene-b-ethylene oxide) block copolymer (PS-PEO), poly(styrene-butadiene), poly(styrene-isoprene-styrene), poly(styrene-b-divinylbenzene) block copolymer, poly(styrene-ethylene oxide-styrene) block copolymer, polystyrene sulfonate (PSS), polyvinyl fluoride (PVF), polymethyl methacrylate (PMMA, poly(methylmethacrylate), polyethylene glycol (PEG), polytetrafluoroethylene (PTFE), polyethylenedioxythiophene (PEDOT), polypyrrole (PPY), Polyacrylonitrile (PAN), polyaniline, polyacetylene, Nafion, Aquivion, Flemion, Gore, Aciplex, Morgane ADP, sulfonated poly(ether ether ketone) (SPEEK), sulfonated poly(arylene ether ketone ketone sulfone) (SPAEKKS), sulfonated poly(aryl ether ketone) (SPAEK), poly[bis(benzimidazobenzisoquinolinones)](SPBIBI), lithium 9,10-diphenylanthracene-2-sulfonate (DPASLi⁺), or a combination thereof. Any polymer electrolyte used in the relevant technical field may be used. Any lithium salt that can be used as a lithium salt in the relevant technical field is possible. The lithium salt is, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (x and y are each 1 to 20), LiCl, LiI, or a mixture thereof. The polymer included in the polymer solid electrolyte may be, for example, a compound including 10 or more, 20 or more, 50 or more, or 100 or more repeating units. The weight average molecular weight of the polymer included in the polymer solid electrolyte may be, for example, 1000 Dalton or more, 10,000 Dalton or more, 100,000 Dalton or more, or 1,000,000 Dalton or more.

The gel electrolyte is, for example, a polymer gel electrolyte. The gel electrolyte may have a gel state without including a polymer.

The polymer gel electrolyte may include a liquid electrolyte and a polymer, or may include an organic solvent and a polymer having an ion-conductive functional group. The polymer gel electrolyte may be, for example, a polymer electrolyte that is in a gel state at 25° C. and 1 atm. The polymer gel electrolyte may have a gel state without including a liquid. The liquid electrolyte used in the polymer gel electrolyte may be, for example, a mixture of an ionic liquid, a lithium salt, and an organic solvent; a mixture of a lithium salt and an organic solvent; a mixture of an ionic liquid and an organic solvent; or a mixture of a lithium salt, an ionic liquid, and an organic solvent. The polymer used in the polymer gel electrolyte may be selected from the polymers used in the solid polymer electrolyte. The organic solvent may be selected from the organic solvents used in the liquid electrolyte. The lithium salt may be selected from the lithium salts used in the polymer solid electrolyte. The ionic liquid is a salt that has a melting point below room temperature and is composed of only ions, is a salt that is liquid at room temperature, or is a molten salt at room temperature. The ionic liquid may include at least one selected from the compounds including a) one or more cations selected from ammonium-based cations, pyrrolidinium-based cations, pyridinium-based cations, pyrimidinium-based cations, imidazolium-based cations, piperidinium-based cations, pyrazolium-based cations, oxazolium-based cations, pyridazinium-based cations, phosphonium-based cations, sulfonium-based cations, triazolium-based cations, and mixtures thereof, and b) one or more anions selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻. The polymer solid electrolyte may form a polymer gel electrolyte by being impregnated into a liquid electrolyte in a secondary battery. The polymer gel electrolyte may further include inorganic particles. The polymer included in the polymer gel electrolyte may be, for example, a compound including 10 or more, 20 or more, 50 or more, or 100 or more repeating units. The weight average molecular weight of the polymer included in the polymer gel electrolyte may be, for example, 500 Dalton or more, 1000 Dalton or more, 10,000 Dalton or more, 100,000 Dalton or more, or 1,000,000 Dalton or more.

The composite electrolyte may include, for example, a carbonate-based solvent.

The carbonate-based solvent may include, for example, a cyclic carbonate-based solvent, a linear carbonate-based solvent, or a combination thereof.

The carbonate-based solvent may include, for example, a cyclic carbonate-based solvent. The cyclic carbonate-based solvent may include, for example, a fluorine-containing cyclic carbonate-based solvent, a fluorine-free cyclic carbonate-based solvent, or a combination thereof.

The cyclic carbonate-based solvent may include, for example, a compound represented by Formula 2 below:

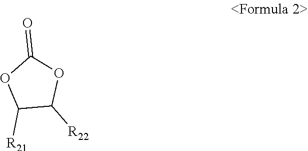

in Formula 2,
R₂₁ and R₂₂ are each independently hydrogen, halogen, or an alkyl group of C1 to C10 substituted or unsubstituted with halogen. In the compound of Formula 2, halogen may be, for example, fluorine (F).

The cyclic carbonate-based solvent may include, for example, ethylene carbonate (EC), propylene carbonate (PC), fluoroethylene carbonate (FEC), 4,4-difluoroethylene carbonate, 4,5-difluoroethylene carbonate, 4-methyl-5-fluoroethylene carbonate, 4-methyl-5,5-difluoroethylene carbonate, 4-(fluoromethyl)ethylene carbonate, 4-(difluoromethyl)ethylene carbonate, 4-(trifluoromethyl)ethylene carbonate, 4-(2-fluoroethyl)ethylene carbonate, 4-(2,2-difluoroethyl)ethylene carbonate, and 4-(2,2,2-trifluoroethyl)ethylene carbonate, 4,5-dimethylethylene carbonate, or a combination thereof.

The carbonate-based solvent may include, for example, a linear carbonate-based solvent. The linear carbonate-based solvent may include, for example, a fluorine-containing linear carbonate-based solvent, a fluorine-free linear carbonate-based solvent, or a combination thereof.

The linear cyclic carbonate-based solvent may include, for example, a compound represented by Formula 3 below:

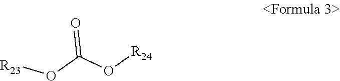

in Formula 3,
R₂₃ and R₂₄ are each independently hydrogen, halogen, or an alkyl group of C1 to C10 substituted or unsubstituted with halogen. In the compound of Formula 3, halogen may be, for example, fluorine (F).

The linear carbonate-based solvent may include, for example, dimethyl carbonate, diethyl carbonate, methyl ethyl carbonate, methyl propyl carbonate, ethyl propyl carbonate, methyl isopropyl carbonate, dipropyl carbonate, dibutyl carbonate, or a combination thereof.

### [Lithium Battery]

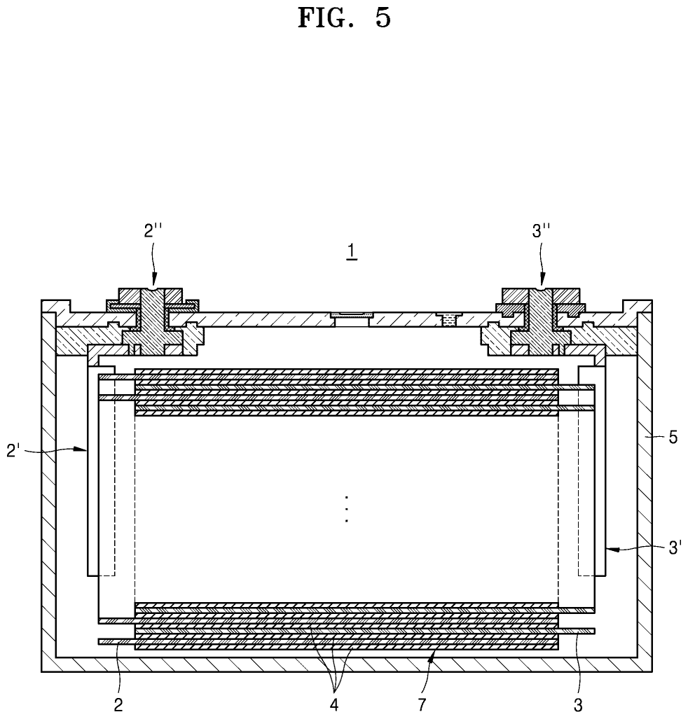

FIGS. 5 to 8 are schematic views of a lithium battery according to an embodiment.

Referring to FIGS. 5 to 8, a lithium battery 1 according to an embodiment includes a cathode 3; an anode 2; and a composite separator 4 or composite electrolyte 4 disposed between the cathode 3 and the anode 2. Since the lithium battery 1 includes the composite separator 4 or the composite electrolyte 4, the heat resistance, flame retardancy, and lifespan characteristics of the lithium battery 1 can be improved.

### (Composite Separator or Composite Electrolyte)

Refer to the above description regarding the composite separator 4 and the composite electrolyte 4.

### (Anode)

A lithium battery 1 includes an anode 2, and the anode 2 includes an anode current collector and an anode active material layer disposed on one surface of the anode current collector.

The anode 2 is manufactured by, for example, the following exemplary method, but is not necessarily limited to this method and is adjusted according to the required conditions.

First, an anode active material, a conductive agent, a binder, and a solvent are mixed to prepare an anode active material composition, and this composition is directly applied onto an anode current collector and dried to prepare an anode plate. Alternatively, the prepared anode active material composition is cast on a separate support, and the anode active material film peeled from the support is laminated to a copper current collector to prepare an anode plate.

Any negative electrode active material that can be used as an anode active material for lithium batteries in the relevant technical field may be used. For example, the anode active material includes at least one selected from a lithium metal, a metal alloyable with lithium, a lithium alloy, a transition metal oxide, a non-transition metal oxide, and a carbon-based material.

Examples of the lithium alloy include, but are not limited to, a Li—Al alloy, a Li—Sn alloy, a Li—In alloy, a Li—Ag alloy, a Li—Au alloy, a Li—Zn alloy, a Li—Ge alloy, and a Li—Si alloy, and any lithium alloy used in the relevant technical field may be used. The anode active material layer may be made of one of these alloys or of lithium, or may be a lithium-containing metal layer or lithium metal layer made of several types of alloys.

The metal alloyable with lithium may be, for example, Si, Sn, Al, Ge, Pb, Bi, Sb, Si—Y alloy (wherein Y is an alkali metal, an alkaline earth metal, a group 13 element, a group 14 element, a transition metal, a rare earth element, or a combination thereof, but not Si), Sn—Y alloy (wherein Y is an alkali metal, an alkaline earth metal, a group 13 element, a group 14 element, a transition metal, a rare earth element, or a combination thereof, but not Sn), or the like. The element Y may be, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or a combination thereof.

The transition metal oxide may be, for example, lithium titanium oxide, vanadium oxide, lithium vanadium oxide, or the like.

The non-transition metal oxide may be, for example, SnO₂, SiOₓ (0<x<2), or the like.

The carbon-based material may be, for example, crystalline carbon, amorphous carbon, or a mixture thereof. The crystalline carbon may be graphite, such as natural graphite or artificial graphite, in the form of amorphous, a plate, a flake, a sphere, or a fiber. The amorphous carbon may be, for example, soft carbon (low-temperature sintered carbon) or hard carbon, mesophase pitch carbide, calcined coke, or the like.

The contents of the anode active material, conductive agent, binder, and solvent are at levels typically used in lithium batteries. Depending on the purpose and configuration of the lithium battery, at least one of the conductive agent, binder, and solvent may be omitted.

The thickness of the anode active material layer may be, for example, about 1 μm to about 200 μm, about 1 μm to about 150 μm, about 1 μm to about 100 μm, about 1 μm to about 50 μm, about 1 μm to about 30 μm, about 1 μm to about 22 μm, or about 1 μm to about 10 μm, but is not limited to these ranges.

The anode current collector includes, for example, a metal substrate. The metal substrate may include, for example, copper (Cu), nickel (Ni), stainless steel (SUS), iron (Fe), and cobalt (Co). The metal substrate may be made of, for example, one of the above-described metals, or an alloy of two or more metals. The metal substrate is, for example, in the form of a sheet or foil. The thickness of the anode current collector is, for example, about 5 μm to about 50 μm, about 10 μm to about 50 μm, about 10 μm to about 40 μm, or about 10 μm to about 30 μm, but is not limited to these ranges.

The anode may include, for example, lithium metal, a lithium alloy, or a combination thereof. Since the anode includes lithium metal, a lithium alloy, or a combination thereof, the energy density of a lithium battery can be improved.

The ion-conductive composite film of the composite separator or composite electrolyte may be disposed adjacent to the anode. Since the ion-conductive composite film of the composite separator or composite electrolyte is disposed adjacent to the anode, the formation of lithium dendrites in the lithium metal may be more effectively suppressed during the charge/discharge process of a lithium battery. As a result, the charge/discharge characteristics of a lithium battery can be further improved.

### (Cathode)

A lithium battery 1 includes a cathode 3, and the cathode 3 includes a cathode current collector and a cathode active material layer disposed on one surface of the cathode current collector.

The cathode 3 is manufactured by, for example, the following exemplary method, but is not necessarily limited to this method and is adjusted according to the required conditions.

First, a cathode active material, a conductive agent, a binder, and a solvent are mixed to prepare a cathode active material composition. The prepared cathode active material composition is directly applied onto an aluminum current collector and dried to prepare a cathode plate having a cathode active material layer formed thereon. Alternatively, the cathode active material composition is cast on a separate support, and then the film obtained by peeling off the support is laminated on the aluminum current collector to manufacture a cathode plate having a cathode active material layer formed thereon.

Examples of the conductive agent may include, but are not limited to, carbon black, graphite particles, natural graphite, artificial graphite, acetylene black, Ketjen black, carbon fibers; carbon nanotubes; metal powders or metal fibers or metal tubes such as copper, nickel, aluminum, and silver; and conductive polymers such as polyphenylene derivatives. Any conductive material used in the relevant technical field may be used.

Examples of the binder, may include, but are not limited to, vinylidene fluoride/hexafluoropropylene copolymer, polyvinylidene fluoride, polyacrylonitrile, polymethyl methacrylate, polytetrafluoroethylene (PTFE), the above polymer mixture, and styrene butadiene rubber polymer, and any binder used in the relevant technical field may be used. Examples of the solvent may include, but are not limited to, N-methylpyrrolidone (NMP), acetone, water, and any solvent used in the relevant technical field may be used.

It is also possible to form pores inside the electrode plate by further adding a plasticizer or a pore forming agent to the cathode active material composition.

The contents of the cathode active material, conductive agent, binder, and solvent are at levels typically used in lithium batteries. Depending on the purpose and configuration of the lithium battery, at least one of the conductive agent, binder, and solvent may be omitted.

The cathode active material layer includes a cathode active material. The cathode active material may be any material used in the relevant technical field, such as a lithium-containing metal oxide. As the cathode active material, at least one of the composite oxides of lithium and a metal selected from cobalt, manganese, nickel, and a combination thereof may be used, and specifically, a compound represented by any one of the formulae of LiₐA_{1-b}B′_{b}D₂ (where 0.90≤a≤1, and 0≤b≤0.5); LiₐE_{1-b}B′_{b}O_{2-c}D_{c} (where 0.90≤a≤1, 0≤b≤0.5, and 0≤c≤0.05); LiE_{2-b}B′_{b}O_{4-c}D (where 0≤b≤0.5, and 0≤c≤0.05); LiₐNi_{1-b-c}Co_{b}B′_{c}D_{α} (where 0.90≤a≤1, 0≤b≤0.5, 0≤c≤0.05, 0<α≤2); LiₐNi_{1-b-c}Co_{b}B′_{c}O_{2-α}F′_{α} (where 0.90≤a≤1, 0≤b≤0.5, 0≤c≤0.05, 0≤a≤2); LiₐNi_{1-b-c}Mn_{b}B′_{c}D_{α} (where 0.90≤a≤1, 0≤b≤0.5, 0≤c≤0.05, 0<α≤2); LiₐNi_{1-b-c}Mn_{b}B′_{c}O_{2-α}F′_{α} (where 0.90≤a≤1, 0≤b≤0.5, 0≤c≤0.05, 0<α<2); LiₐNi_{1-b-c}Mn_{b}B′_{c}O_{2-α}F′_{α} (where 0.90≤a≤1, 0≤b≤0.5, 0≤c≤0.05, 0<α<2); LiₐNi_{b}E_{c}G_{d}O₂(where 0.90≤a≤1, 0≤b≤0.90, 0≤c≤0.5, 0.001≤d≤0.1.); LiₐNi_{b}Co_{c}Mn_{d}GₑO₂ (where 0.90≤a≤1, 0.5≤b≤0.9, 0≤c≤0.5, 0≤d≤0.5, 0.001≤e≤0.1.); LiₐNiG_{b}O₂ (where 0.90≤a≤1, 0.001≤b≤0.1); LiₐCoG_{b}O₂ (where 0.90≤a≤1, 0.001≤b≤0.1); LiₐMnG_{b}O₂ (where 0.90≤a≤1, 0.001≤b≤0.1); LiₐMn₂G_{b}O₄ (where 0.90≤a≤1, 0.001≤b≤0.1); QO₂; QS₂; LiQS₂; V₂O₅; LiV₂O₅; LiI′O₂; LiNiVO₄; Li_{(3-f)}J₂(PO₄)₃ (0≤f≤2); Li_{(3-f)}Fe₂(PO₄)₃ (0≤f≤2); and LiFePO₄ may be used.

In the formulae representing the above-described compounds, A is Ni, Co, Mn, or a combination thereof; B′ is Al, Ni, Co, Mn, Cr, Fe, Mg, Sr, V, a rare earth element, or a combination thereof; D is 0, F, S, P, or a combination thereof; E is Co, Mn, or a combination thereof; F′ is F, S, P, or a combination thereof; G is Al, Cr, Mn, Fe, Mg, La, Ce, Sr, V, or a combination thereof; Q is Ti, Mo, Mn, or a combination thereof; I′ is Cr, V, Fe, Sc, Y, or a combination thereof; and J is V, Cr, Mn, Co, Ni, Cu, or a combination thereof. It is possible to use a compound having a coating layer added to the surface of the above-described compound, and it is also possible to use a mixture of the above-described compound and a compound having a coating layer. The coating layer added to the surface of the above-described compound includes a coating element compound, for example, an oxide of a coating element, a hydroxide of a coating element, an oxyhydroxide of a coating element, an oxycarbonate of a coating element, or a hydroxycarbonate of a coating element. The compound forming this coating layer is amorphous or crystalline. The coating element included in the coating layer is Mg, Al, Co, K, Na, Ca, Si, Ti, V, Sn, Ge, Ga, B, As, Zr, or a mixture thereof. The method of forming the coating layer is selected within a range that does not adversely affect the properties of the cathode active material. Coating methods include spray coating, dipping, and the like. Since the specific coating method is well understood by those skilled in the art, a detailed description thereof will be omitted.

The cathode active material may include, for example, lithium transition metal oxides represented by Formulae 4 to 11 below:

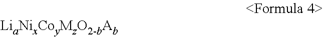

in Formula 4,
1.0≤a≤1.2, 0≤b≤0.2, 0.8≤x<1, 0≤y≤0.3, 0<z≤0.3, and x+y+z=1,
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A is F, S, Cl, Br, or a combination thereof,

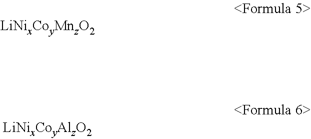

in Formulae 5 and 6, 0.8≤x≤0.95, 0≤y≤0.2, 0<z≤0.2 and x+y+z=1,

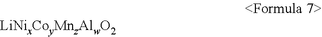

in Formula 7, 0.8≤x≤0.95, 0≤y≤0.2, 0<z≤0.2, 0<w≤0.2, and x+y+z+w=1,

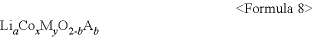

in Formula 8,
1.0≤a≤1.2, 0≤b≤0.2, 0.95≤x≤1, 0≤y≤0.1, and x+y=1,
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A is F, S, Cl, Br or a combination thereof,

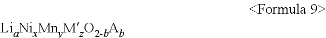

In Formula 9,
1.0≤a≤1.2, 0≤b≤0.2, 0<x≤0.3, 0.5≤y<1, 0<z≤0.3, and x+y+z=1,
M′ is cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B) or a combination thereof, and
A is F, S, Cl, Br or a combination thereof,

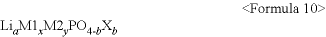

in Formula 10, 0.90≤a≤1.1, 0≤x≤0.9, 0≤y≤0.5, 0.9<x+y<1.1, 0≤b≤2,
M1 is chromium (Cr), manganese (Mn), iron (Fe), cobalt (Co), nickel (Ni), copper (Cu), zirconium (Zr) or a combination thereof,
M2 is magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or a combination thereof, and X is O, F, S, P or a combination thereof,

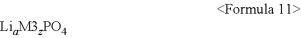

In Formula 11, 0.90≤a≤1.1, 0.9≤z≤1.1, and
M3 is chromium (Cr), manganese (Mn), iron (Fe), cobalt (Co), nickel (Ni), copper (Cu), zirconium (Zr), or a combination thereof.

The thickness of the cathode active material layer is, for example, about 1 μm to about 200 μm, about 1 μm to about 150 μm, about 1 μm to about 100 μm, about 1 μm to about 50 μm, about 1 μm to about 30 μm, about 1 μm to about 22 μm, or about 1 μm to about 10 μm, but is not limited to these ranges.

The cathode current collector includes, for example, a metal substrate. The metal substrate may be made of, for example, aluminum (Al), indium (In), copper (Cu), magnesium (Mg), stainless steel, titanium (Ti), iron (Fe), cobalt (Co), nickel (Ni), zinc (Zn), germanium (Ge), or an alloy thereof. The metal substrate may be made of, for example, one of the above-described metals, or an alloy of two or more metals. The metal substrate is, for example, in the form of a sheet or foil. The thickness of the cathode current collector is, for example, about 5 μm to about 50 μm, about 10 μm to about 50 μm, about 10 μm to about 40 μm, or about 10 μm to about 30 μm, but is not limited to these ranges.

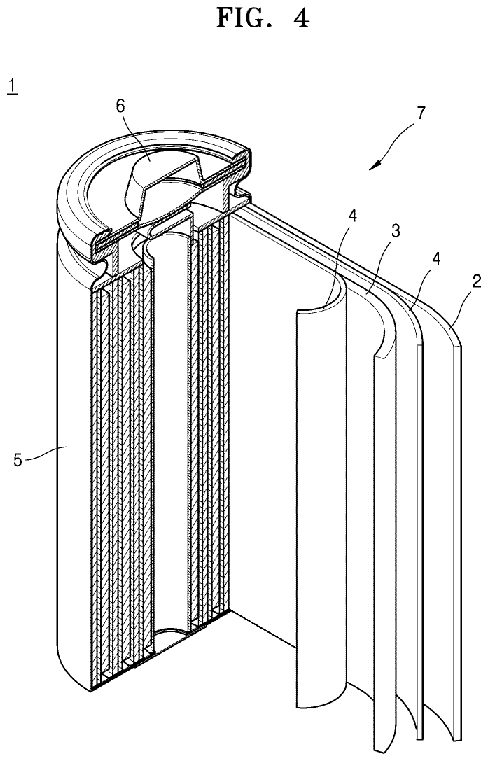

A lithium battery 1 may have a structure of FIGS. 4 to 7 below.

Referring to FIG. 4, a lithium battery 1 according to an embodiment includes a cathode 3, the above-described anode 2, and a composite separator 4. The cathode 3, the anode 2, and the composite separator 4 are wound or folded to form a battery structure 7. The battery structure 7 is accommodated in a battery case 5. An electrolyte is injected into the battery case 5, cross-linked, and sealed with a cap assembly 6 to complete the lithium battery 1. The battery case 5 is cylindrical, but is not necessarily limited to this shape, and may be, for example, rectangular, thin film, or the like.

Referring to FIG. 5, a lithium battery 1 according to an embodiment includes a cathode 3, the above-described anode 2, and a composite separator 4. The cathode 3, the anode 2, and the composite separator 4 are wound, folded, or stacked to form a battery structure 7. The battery structure 7 is accommodated in a battery case 5. An electrolyte is injected into the battery case 5, cross-linked, and sealed to complete the sodium battery 1. The battery case 5 is rectangular, but is not necessarily limited to this shape, and may be, for example, cylindrical, thin film, or the like. A cathode lead tab 3′ and a cathode terminal 3″ are electrically connected to the cathode 3. An anode lead tab 2′ and an anode terminal 2″ are electrically connected to the anode 3.

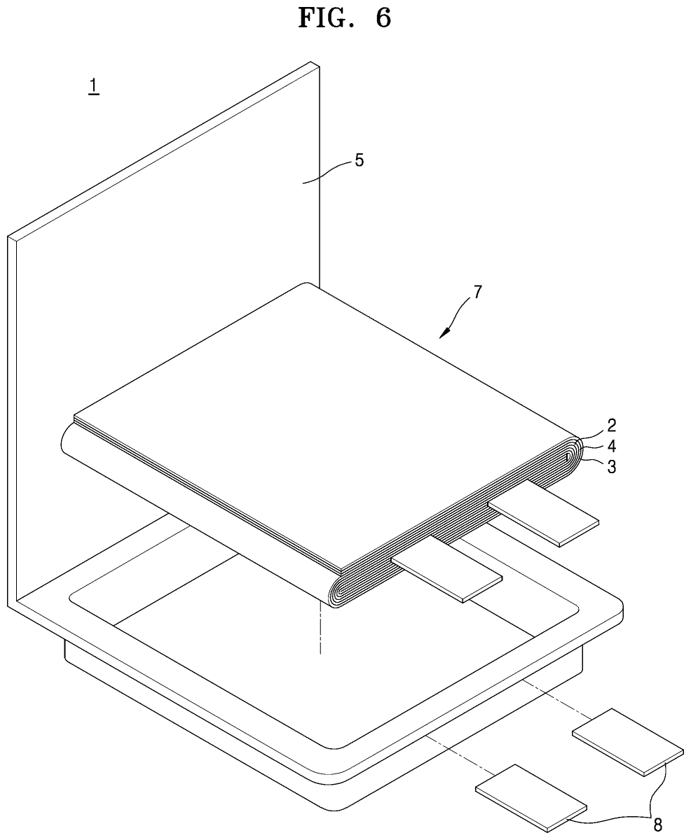

Referring to FIG. 6, a lithium battery 1 according to an embodiment includes a cathode 3, the above-described anode 2, and a composite separator 4. The composite separator 4 is disposed between the cathode 3 and the anode 2, and the cathode 3, the anode 2, and the composite separator 4 are wound or folded to form a battery structure 7. The battery structure 7 is accommodated in a battery case 5. The battery case 5 may include electrode tabs 8 serving as electrical paths for inducing a current formed in the battery structure 7 to the outside. An electrolyte is injected into the battery case 5, cross-linked, and sealed to complete the lithium battery 1. The battery case 5 is rectangular, but is not necessarily limited to this shape, and may be, for example, cylindrical, thin film, or the like.

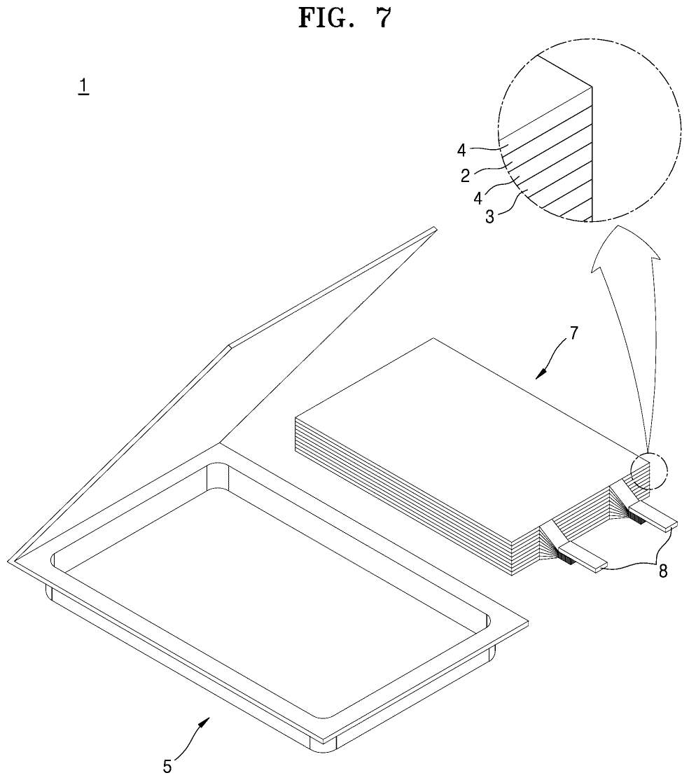

Referring to FIG. 7, a lithium battery 1 according to an embodiment includes a cathode 3, the above-described anode 2, and a composite separator 4. The composite separator 4 is disposed between the cathode 3 and the anode 2 to form a battery structure 7. The battery structure 7 is stacked as a bi-cell structure and then accommodated in a battery case 5. The battery case 5 may include electrode tabs 8 serving as electrical paths for inducing a current formed in the battery structure 7 to the outside. An electrolyte is injected into the battery case 5, cross-linked, and sealed to complete the lithium battery 1. The battery case 5 is rectangular, but is not necessarily limited to this shape, and may be, for example, cylindrical, thin film, or the like.

A pouch-type lithium battery uses a pouch as the case for the lithium battery of FIGS. 4 to 7. The pouch-type lithium battery may include at least one battery structure. A separator is disposed between a cathode and an anode to form a battery structure. The plurality of battery structures are stacked in a thickness direction, impregnated with an organic electrolyte, and then accommodated and sealed in a pouch to complete the pouch-type lithium metal battery. For example, although not shown in the drawings, the above-described cathode, anode, and separator may be simply stacked and accommodated in a pouch in the form of an electrode assembly, or may be wound or folded into a jelly roll-shaped electrode assembly and then accommodated in a pouch. Subsequently, an electrolyte is injected into the pouch and sealed to complete a lithium battery.

Since the lithium battery of the disclosure has excellent lifespan characteristics and high energy density, it is used in electric vehicles (EVs). For example, the lithium battery is used in hybrid vehicles such as plug-in hybrid electric vehicles (PHEVs). The lithium battery is also used in fields that require large amounts of power storage. For example, the lithium battery is used in electric bicycles, power tools, or the like.

The plurality of lithium batteries are stacked to form a battery module, and the plurality of battery modules are formed into a battery pack. This battery pack may be used in any device that requires high capacity and high output. For example, the battery pack may be used in laptops, smartphones, electric vehicles, and the like. The battery module includes a plurality of batteries and a frame holding these batteries. The battery pack includes a plurality of battery modules and a bus bar connecting these battery modules. The battery module and/or battery pack may further include a cooling device. The plurality of battery packs are controlled by a battery management system. The battery management system includes a battery pack and a battery control device connected to the battery pack.

Hereinafter, the present inventive concept will be described in more detail through the following examples and comparative examples. However, the examples are intended to illustrate the present inventive concept and the scope of the present inventive concept is not limited to these examples.

### (Preparation of Oxide-Based Solid Electrolytes)

### Preparation Examples 1 to 6: Preparation of Oxide-Based Solid Electrolytes

Al₂O₃ as an aluminum precursor, Ga₂O₃ as a gallium precursor, Ta₂O₅ as a tantalum precursor, Li₂CO₃ as a lithium precursor, La₂O₃ as a lanthanum precursor, and ZrO₂ as a zirconium precursor were mixed in a stoichiometric ratio, added to isopropyl alcohol (IPA), and milled using a planetary mill. To prevent lithium volatilization during calcination, Li₂CO₃, a lithium precursor, was added in an amount of 10% or 20% in addition to the stoichiometric ratio. The ball-milled solution was dried, and then calcined in a furnace at 1000° C. or 1250° C. for 6 hours to prepare a LLZO oxide-based solid electrolyte. The preparation temperature, added Li₂CO₃ content, and composition of the oxide-based solid electrolyte are shown in Table 1 below. The composition of the oxide-based solid electrolyte was determined by inductively coupled plasma atomic emission spectroscopy (ICP-AES).

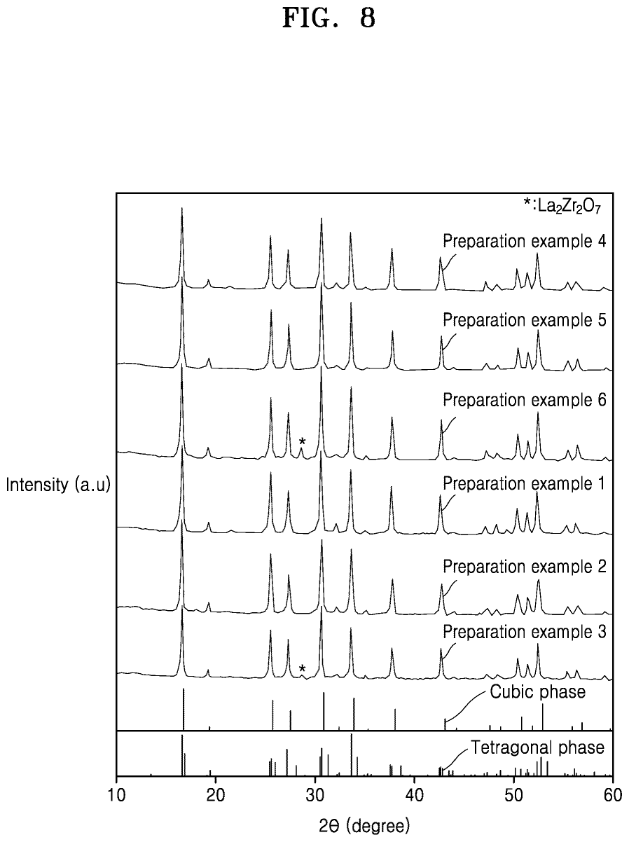

XRD spectra were measured for the oxide-based solid electrolytes prepared in Preparation Examples 1 to 6, and the measurement results thereof are shown in FIG. 8.

As shown in FIG. 8, it was confirmed that the oxide-based solid electrolytes prepared in Preparation Examples 1 to 6 mainly included a cubic phase and hardly included a tetragonal phase.

TABLE 1

| | Sintering | |
|---|---|---|
| | temperature and | |
| | added Li₂CO₃ | |
| | content | Solid electrolyte composition |
| Preparation | 1000° C. / 20% | Li_{7.59}La₃Zr_{1.87}Ga_{0.06}Ta_{0.01}Al_{0.18}O₁₂ |
| Example 1 | | |
| Preparation | 1000° C. / 10% | Li_{6.88}La₃Zr_{1.84}Ga_{0.06}Ta_{0.01}Al_{0.17}O₁₂ |
| Example 2 | | |
| Preparation | 1000° C. / 0% | Li_{6.18}La₃Zr_{1.85}Ga_{0.06}Ta_{0.02}Al_{0.19}O₁₂ |
| Example 3 | | |
| Preparation | 1250° C. / 20% | Li_{7.09}La₃Zr_{1.90}Ga_{0.06}Ta_{0.01}Al_{0.18}O₁₂ |
| Example 4 | | |
| Preparation | 1250° C. / 10% | Li_{6.58}La₃Zr_{1.92}Ga_{0.06}Ta_{0.01}Al_{0.19}O₁₂ |
| Example 5 | | |
| Preparation | 1250° C. / 0% | Li_{6.07}La₃Zr_{1.86}Ga_{0.06}Ta_{0.01}Al_{0.19}O₁₂ |
| Example 6 | | |

### (Preparation of Ion-Conductive Composite Films)

### Preparation Example 7: Preparation of Ion-Conductive Composite Film (Li_{7.59} LLZO+EVA), LLZO 90 wt %

The solid electrolyte powder prepared in Preparation Example 1 and ethylene-vinyl acetate (EVA) were added to a chlorobenzene solvent at a weight ratio of 90:10 and stirred to prepare a mixed solution. The mixed solution was introduced into a planetary mill and milled to prepare a milled mixed solution. The milled mixed solution was tape-cast on a glass substrate using a doctor blade, the solvent was removed, and an ion-conductive composite film was separated from the glass substrate. The ion-conductive composite film was a free-standing film.

### Preparation Example 8: Preparation of Ion-Conductive Composite Film (Li_{6.07} LLZO+EVA), LLZO 90 wt %

An ion-conductive composite film was prepared in the same manner as in Preparation Example 7, except that the solid electrolyte powder prepared in Preparation Example 6 was used instead of the solid electrolyte powder prepared in Preparation Example 1.

### Comparative Preparation Example 1: Preparation of Ion-Conductive Composite Film (Li_{7.59} LLZO+EVA), LLZO 50 wt %

An ion-conductive composite film was prepared in the same manner as in Preparation Example 7, except that the mixing weight ratio of the solid electrolyte powder prepared in Preparation Example 1 and ethylene-vinyl acetate (EVA) was changed to 50:50.

### (Preparation of Composite Separators)

### Example 1: Second Layer (PVDF, Thickness 10 μm)/First Layer (Ion-Conductive Composite Film, Li_{7.59} LLZO+EVA, Thickness 50 μm, LLZO 90 wt %)/Third Layer (PVDF, Thickness 10 μm)

A first polymer (PVDF) composition was applied onto one surface of the ion-conductive composite film prepared in Preparation Example 7 using a doctor blade, and then a solvent was removed to introduce a second layer. Subsequently, a third layer was introduced on the other surface of the ion-conductive composite film prepared in Preparation Example 7 in the same manner, and hot pressing was performed to prepare a three-layer composite separator. The first polymer composition was prepared by dissolving polyvinylidene fluoride (PVDF) in a DMF solvent. The thickness of the three-layer composite separator was about 70 μm, the thickness of the first layer 10 was about 50 μm, and the thicknesses of the second layer 20 and the third layer 30 were each about 10 μm.

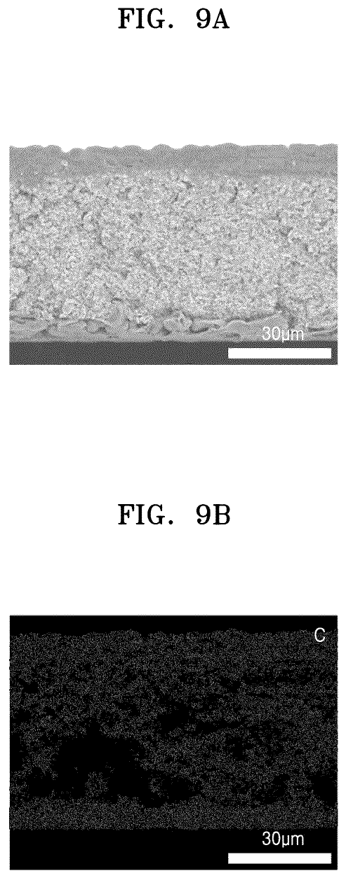

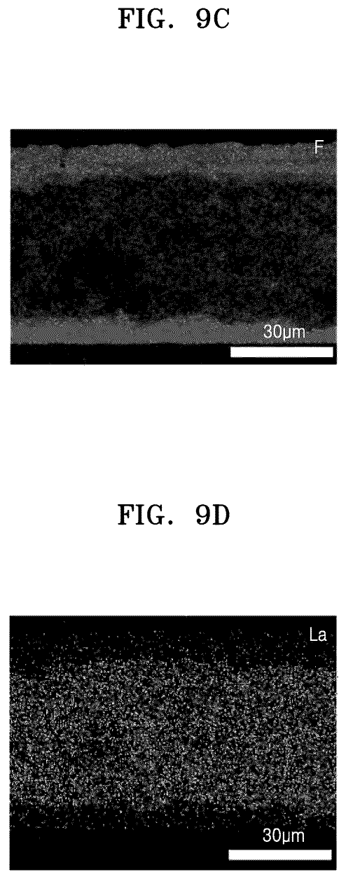

SEM and EDS analysis images of the cross-section of the manufactured composite separator are shown in FIGS. 9A to 9D.

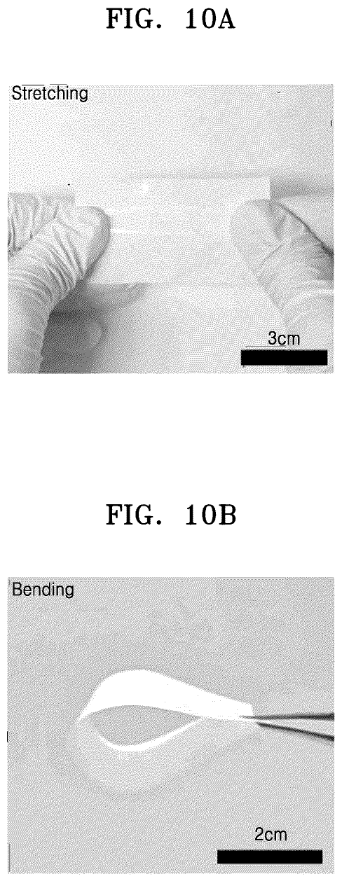

Images of the stretched composite separator and the bent composite separator are shown in FIGS. 10A and 10B, respectively.

### Example 2: Second Layer (PVDF, Thickness 10 Um)/First Layer (Ion-Conductive Composite Film, Li_{6.07} LLZO+EVA, Thickness 50 μm, LLZO 90 wt %)/Third Layer (PVDF, thickness 10 μm)

An ion-conductive composite film was prepared in the same manner as in Example 1, except that the ion-conductive composite film prepared in Preparation Example 8 was used instead of the solid electrolyte powder prepared in Preparation Example 7.

The thickness of the composite separator was about 70 μm, the thickness of the first layer 10 was about 50 μm, and the thicknesses of the second layer 20 and the third layer 30 were each about 10 μm.

### Comparative Example 1: Celgard Separator

A commercially available separator (Celgard 2400) was used as it is.

### Comparative Example 2: PVDF Single-Layer Separator

The first polymer (PVDF) composition used in Example 1 was applied onto a substrate using a doctor blade, and then a solvent was removed, separated from the substrate, and used as a separator.

The thickness of the PVDF separator was about 70 μm.

### Comparative Example 3: Two-Layer Separator of Second Layer (PVDF, Thickness 10 μm)/First Layer (Ion-Conductive Composite Film, Li_{7.59}LLZO+EVA, Thickness 50 μm, LLZO 90 wt %)

A composite separator was prepared in the same manner as Example 1, except that the second layer 20 was introduced on one surface of the ion-conductive composite film prepared in Preparation Example 7 and the third layer 30 was not introduced.

The thickness of the separator was about 60 μm.

### Comparative Example 4: Three-Layer Separator of First Layer (Ion-Conductive Composite Film, Li_{7.59} LLZO+EVA, Thickness 50 μm, LLZO 90 wt %)/Second Layer (PVDF, Thickness 10 μm)/First Layer (Ion-Conductive Composite Film, Li_{7.59} LLZO+EVA, Thickness 50 μm, LLZO 90 wt %)

A composite separator was prepared in the same manner as in Example 1, except that the ion-conductive composite films prepared in Preparation Example 7 was introduced on both surfaces of the PVDF second layer.

The thickness of the separator was about 110 μm.

### Comparative Example 5: Second Layer (PVDF, Thickness 10 Um)/First Layer (Ion-Conductive Composite Film, Li_{7.59}LLZO+EVA, Thickness 50 μm, LLZO 50 wt %)/Third Layer (PVDF, Thickness 10 μm)

A composite separator was prepared in the same manner as Example 1, except that the ion-conductive composite film prepared in Comparative Preparation Example 1 was used instead of the ion-conductive composite film prepared in Preparation Example 7.

### Evaluation Example 1: Morphology Measurement

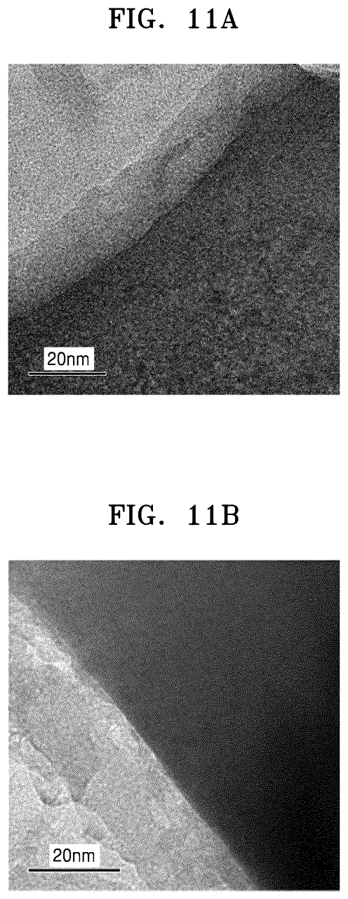

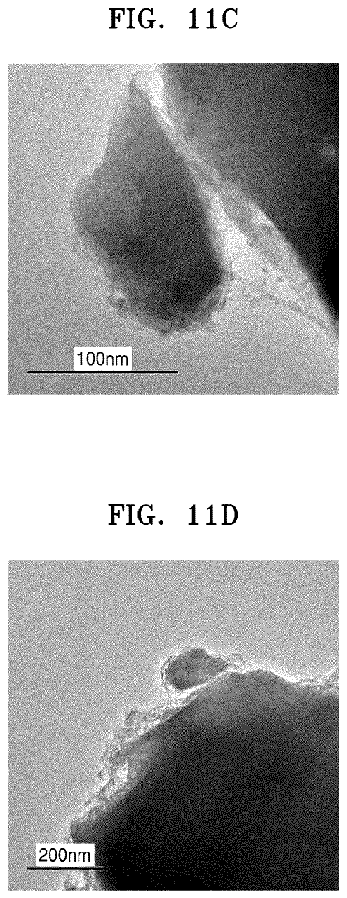

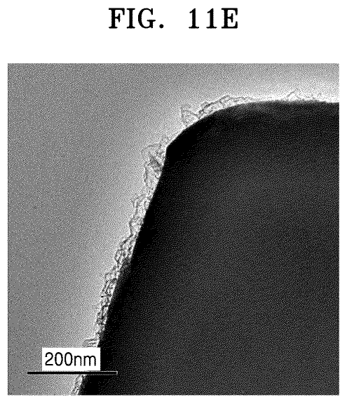

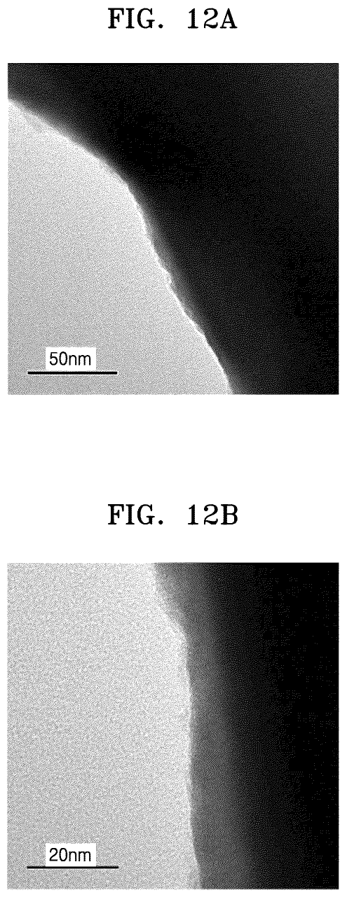

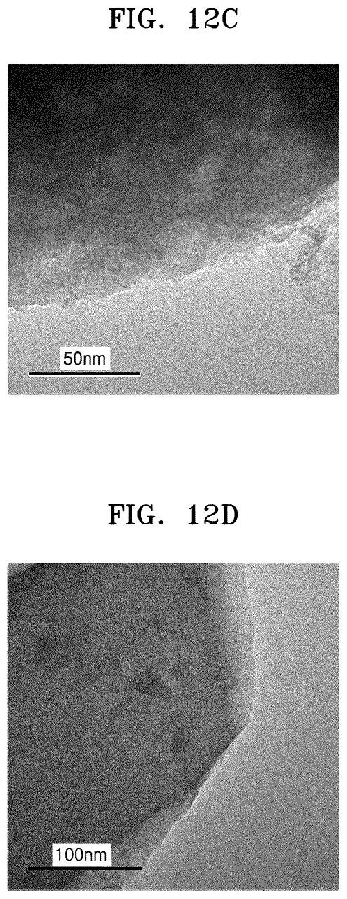

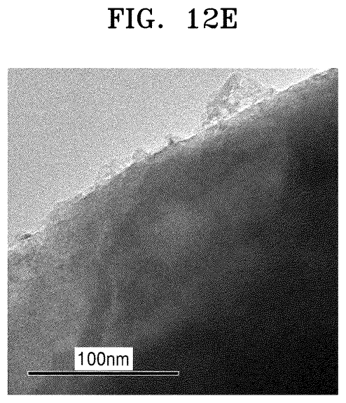

The surface morphology of the LLZO solid electrolyte particles doped with Ga, Ta, and Al, prepared in Preparation Examples 1 and 6 was measured using a transmission electron microscope (TEM). The measurement results thereof are shown in FIGS. 11A to 11E and FIGS. 12A to 12E, respectively.

FIGS. 11A to 11E are transmission electron microscope images of LLZO solid electrolyte particles prepared in Preparation Example 1.

FIGS. 12A to 12E are transmission electron microscope images of LLZO solid electrolyte particles prepared in Preparation Example 6.

As shown in FIGS. 11A to 11E, it was confirmed that the LLZO solid electrolyte particles having a high lithium content, prepared in Preparation Example 1, included a conformal coating layer disposed along a contour of the surface of the solid electrolyte particles on the surface thereof. The thickness of the conformal coating layer was about 20 nm to about 30 nm. By measuring the IR spectrum of the solid electrolyte particles, it was confirmed that the conformal coating layer included a lithium-containing compound such as Li₂CO₃ or LiOH.

As shown in FIGS. 12A to 12E, it was confirmed that the LLZO solid electrolyte particles having a low lithium content, prepared in Preparation Example 6, did not include a conformal coating layer disposed along a contour of the surface of the solid electrolyte particles on the surface thereof. It was confirmed that a lithium-containing compound remained in the form of an island on some of the surfaces of the LLZO solid electrolyte particles.

### Evaluation Example 2: XPS Depth Profile Measurement

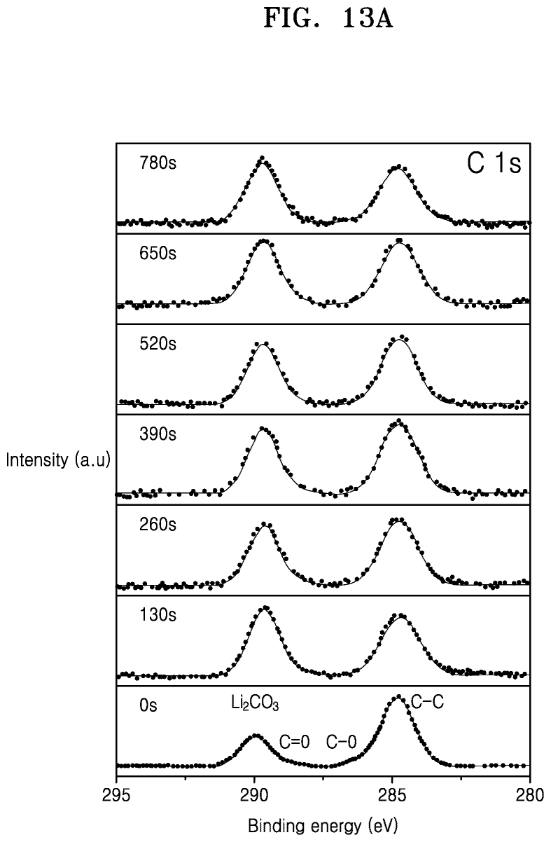

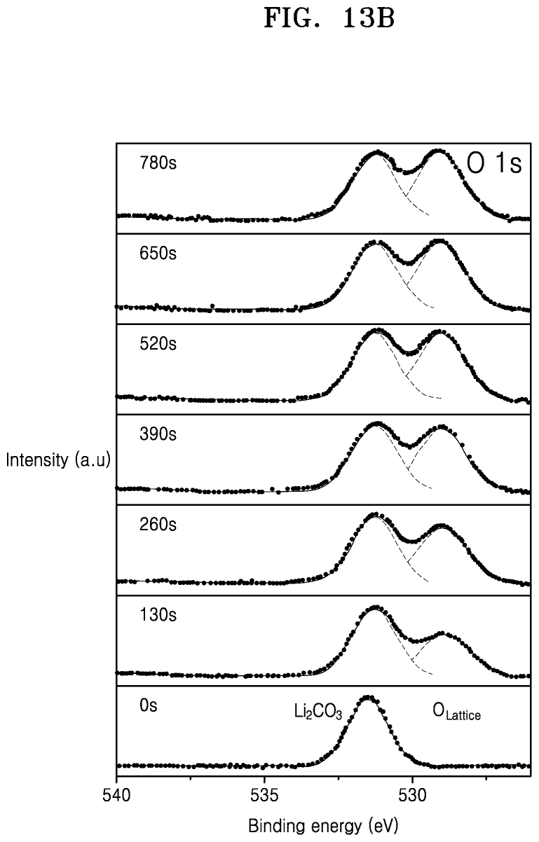

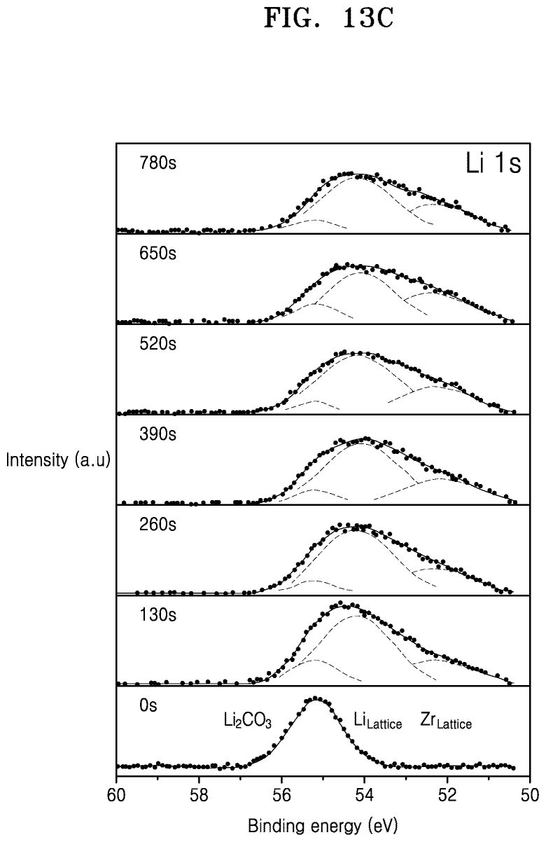

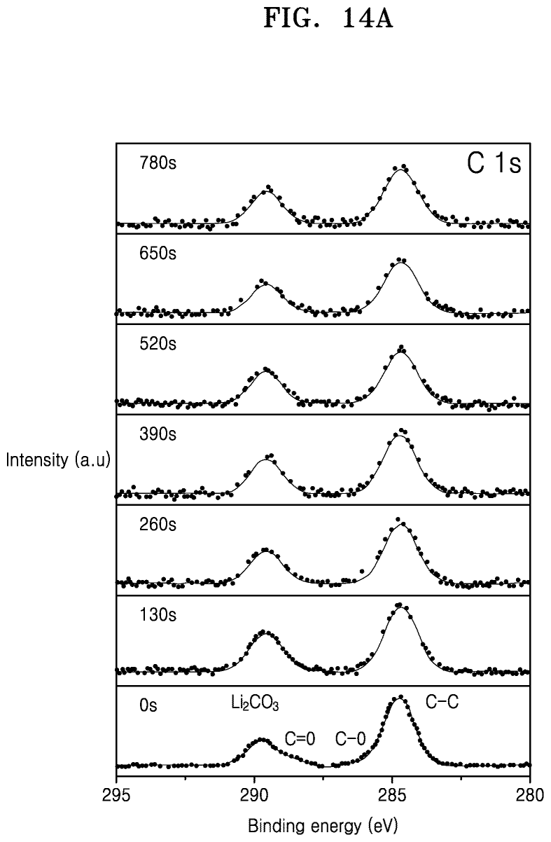

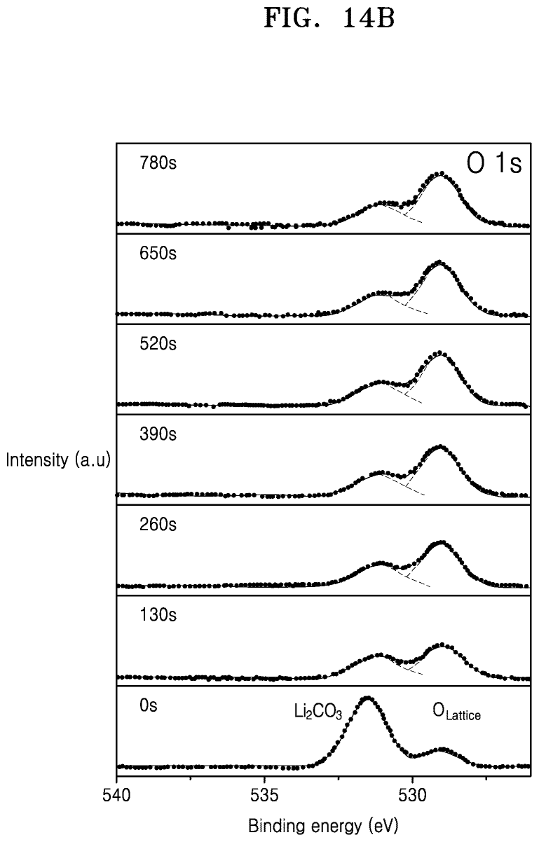

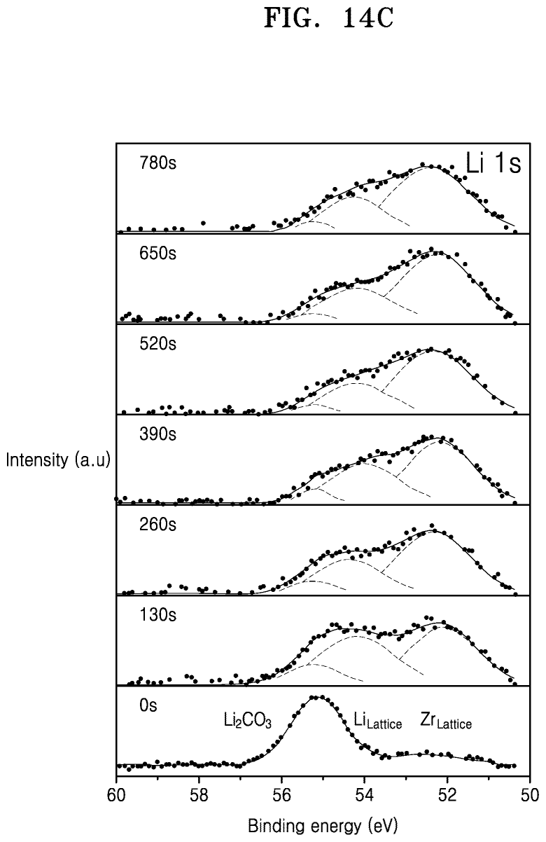

The surface of the LLZO solid electrolyte particles doped with Ga, Ta, and Al, prepared in Preparation Examples 1 and 6, was etched by ion sputtering, and simultaneously the composition thereof according to depth was analyzed to measure a depth profile. The measurement results thereof are shown in FIGS. 13A to 13C and FIGS. 14A to 14C, respectively.

Ion sputtering was performed using, for example, an Ar⁺ ion beam.

FIGS. 13A to 13C show the XPS depth profile measurement results of the surface of the LLZO solid electrolyte particles prepared in Preparation Example 1.

FIGS. 14A to 14C show the XPS depth profile measurement results of the surface of the LLZO solid electrolyte particles prepared in Preparation Example 6.

FIGS. 13A and 14A are graphs showing changes in carbon peak intensity according to etching time. The peak on the left is a peak derived from the C═O bond of Li₂CO₃.

FIGS. 13B and 14B are graphs showing changes in oxygen peak intensity according to etching time. The peak on the left is a peak derived from oxygen of Li₂CO₃, and the peak on the right is a peak derived from oxygen (O_{lattice}) in the lattice of the LLZO solid electrolyte.

FIGS. 13C and 14C are graphs showing changes in lithium peak intensity according to etching time. The peak on the left is a peak derived from lithium of Li₂CO₃, the peak in the middle is a peak derived from lithium (Li_{lattice}) in the LLZO lattice, and the peak on the right is a peak derived from zirconium (Zr_{lattice}) in the LLZO lattice.

As shown in FIG. 13B, the LLZO solid electrolyte particles prepared in Preparation Example 1 were free of a second oxygen peak derived from oxygen (O_{lattice}) in the lattice of the LLZO solid electrolyte at a binding energy of 527.5 eV to 530 eV at the beginning of sputtering (that is, 0 second). In FIG. 13B, it was found that a coating layer containing Li₂CO₃ was dominantly disposed on the surface of the LLZO solid electrolyte.

As shown in FIG. 13B, in the LLZO solid electrolyte prepared in Preparation Example 1, the ratio (P2/P1) of the intensity of the first oxygen peak (P1) derived from lithium carbonate (Li₂CO₃) at a binding energy of 530 eV to 532.5 eV and the intensity of the second oxygen peak (P2) derived from the lattice oxygen (O_{lattice}) of the LLZO solid electrolyte at a binding energy of 527.5 eV to 530 eV was 1 or less in the range of 130 seconds to 780 seconds from the beginning of sputtering. In FIG. 13B, it was found that the thickness of the coating layer containing Li₂CO₃ present on the surface of the LLZO solid electrolyte is large.

In contrast, as shown in FIG. 14B, the LLZO solid electrolyte prepared in Preparation Example 6 had a second oxygen peak derived from the lattice oxygen (O_{lattice}) of the LLZO solid electrolyte at a binding energy of 527.5 eV to 530 eV at the beginning of sputtering (that is, 0 second). In FIG. 14B, it was found that LLZO having a cubic phase in addition to the coating layer containing Li₂CO₃ was exposed to the surface of the LLZO solid electrolyte.

As shown in FIG. 14B, in the LLZO solid electrolyte prepared in Preparation Example 1, the ratio (P2/P1) of the intensity of the first oxygen peak (P1) derived from lithium carbonate (Li₂CO₃) at a binding energy of 530 eV to 532.5 eV and the intensity of the second oxygen peak (P2) derived from the lattice oxygen (O_{lattice}) of the LLZO solid electrolyte at a binding energy of 527.5 eV to 530 eV was less than 1 after 130 seconds from the beginning of sputtering. In FIG. 14B, it was found that the thickness of the coating layer containing Li₂CO₃ present on the surface of the LLZO solid electrolyte is very small.

### Evaluation Example 3: FT-IR Measurement

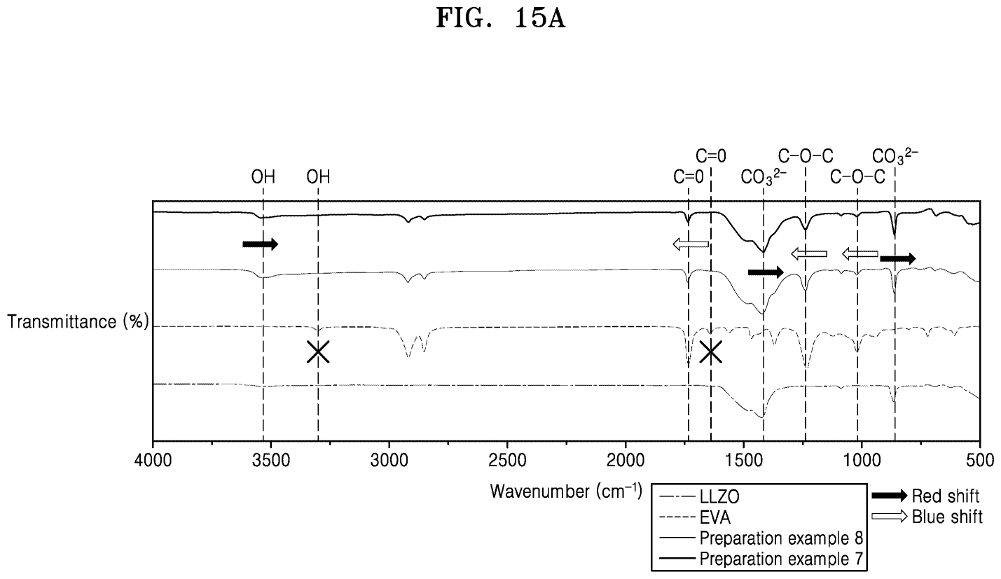

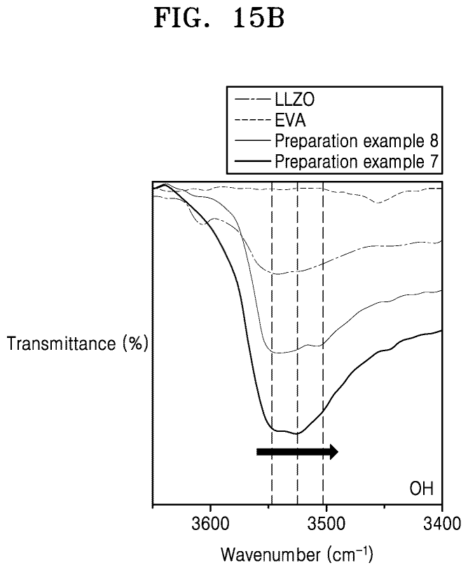

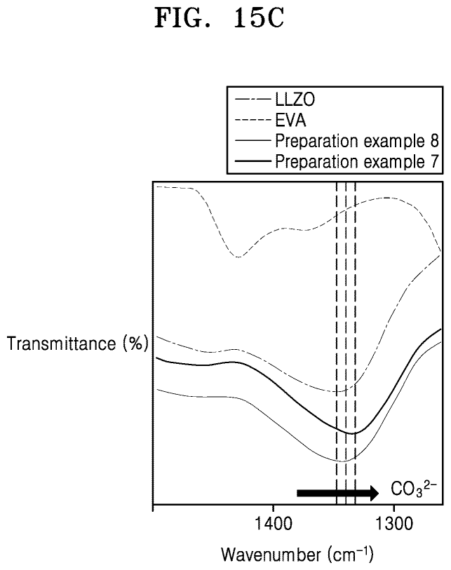

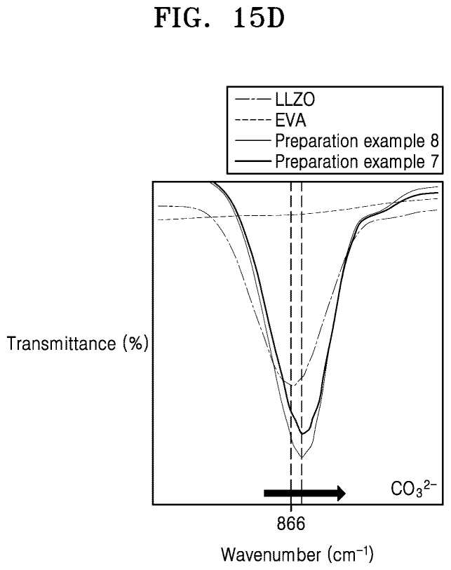

FT-IR was measured for the solid electrolyte prepared in Preparation Example 1, the ethylene-vinyl acetate (EVA) polymer used in Preparation Example 7, and the ion-conductive composite films prepared in Preparation Examples 7 and 8, respectively, and the measurement results thereof are shown in FIGS. 15A to 15D.

FIG. 15A shows the FT-IR spectra for the solid electrolyte prepared in Preparation Example 1, the ethylene-vinyl acetate (EVA) polymer used in Preparation Example 7, and the ion-conductive composite films prepared in Preparation Examples 7 and 8.

FIGS. 15B to 15D are partial enlarged views of FIG. 15A.

Referring to FIG. 15B, the positions of the OH peaks in the ion-conductive composite films of Preparation Examples 7 and 8 showed a red shift toward a lower wavenumber compared to the position of the OH peak of LLZO at a wavenumber of 3550 cm⁻¹. LiOH disposed on the LLZO solid electrolyte forms hydrogen bonds with the carbonyl group (C═O) and ether group (C—O—C) of the ethylene-vinyl acetate (EVA) polymer, thereby showing a red shift in which the intensity of the peak at 3550 cm⁻¹ derived from the OH bond decreases and the intensity of the peak at 3500 cm⁻¹ increases.

Referring to FIGS. 15C and 15D, the positions of the CO₃²⁻ peaks in the ion-conductive composite films of Preparation Examples 7 and 8 showed a red shift toward a lower wavenumber compared to the CO₃²⁻ peaks of LLZO at 1423 cm⁻¹ and 866 cm⁻¹. Li₂CO₃ disposed on the LLZO solid electrolyte forms hydrogen bonds with the C—H groups of the ethylene-vinyl acetate (EVA) polymer, thereby showing a red shift in which the peak positions at 1423 cm⁻¹ and 866 cm⁻¹ derived from the CO₃²⁻ bond move toward a lower wave number.

Referring to FIGS. 15A to 15D, it was found that the ion-conductive composite film prepared in Preparation Example 7 forms stronger hydrogen bonds than the ion-conductive composite film prepared in Preparation Example 8, thereby showing a greater red shift. It was confirmed that the ion-conductive composite film of Preparation Example 7 was more strongly bound to the EVA polymer through hydrogen bonds than the ion-conductive composite film of Preparation Example 8 because it includes a thick conformal coating layer containing LiOH, Li₂CO₃, or the like.

### Evaluation Example 4: Thermal Stability Evaluation

Thermal stability was evaluated for the separator (Celgard) of Comparative Example 1, the ion-conductive composite film (LLZO-EVA) separator prepared in Preparation Example 7, and the composite separator prepared in Example 1.

Thermal stability was evaluated by measuring the thermal shrinkage rate of a specimen.

The thermal shrinkage rate was evaluated from a change in area after leaving (after heat-treating) circular specimens in an oven at 60° C., 80° C., 100° C., 120° C., 140° C., 160° C., 180° C., and 200° C. for 30 minutes, respectively.

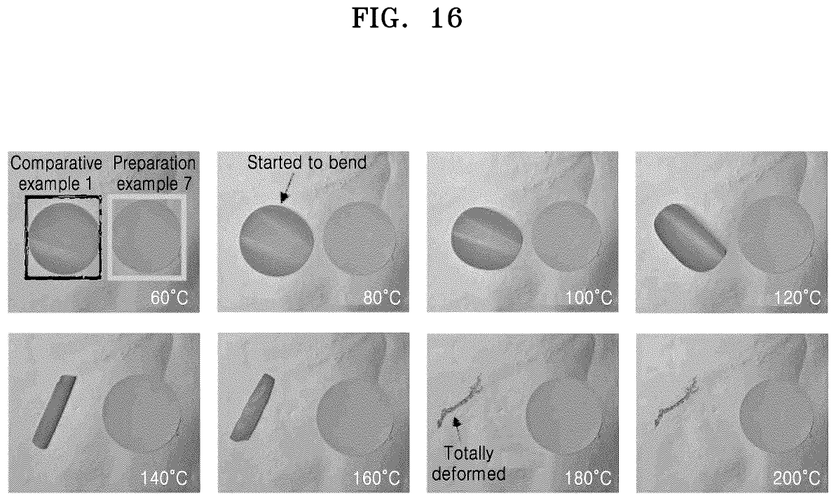

The thermal shrinkage rate was determined by whether the specimen was bent or melted after heat treatment. The evaluation results thereof are shown in FIG. 16.

As shown in FIG. 16, the separator of Comparative Example 1 on the left began to be bent from 100° C. and was completely melted at 180° C.

In contrast, the ion-conductive composite film of Preparation Example 7, that is, the first layer 10, showed excellent thermal stability without thermal shrinkage.

Although not shown in the drawing, the composite separator 50 including a second layer and a third layer arranged on both surfaces of the first layer 10 also showed excellent thermal stability.

### Evaluation Example 5: Flame Retardancy Evaluation (I)

Flame retardancy was evaluated for the separator (Celgard) of Comparative Example 1, the separator (PVDF) of Comparative Example 2, and the composite separator (PVDF/LLZO/PVDF) prepared in Example 1.

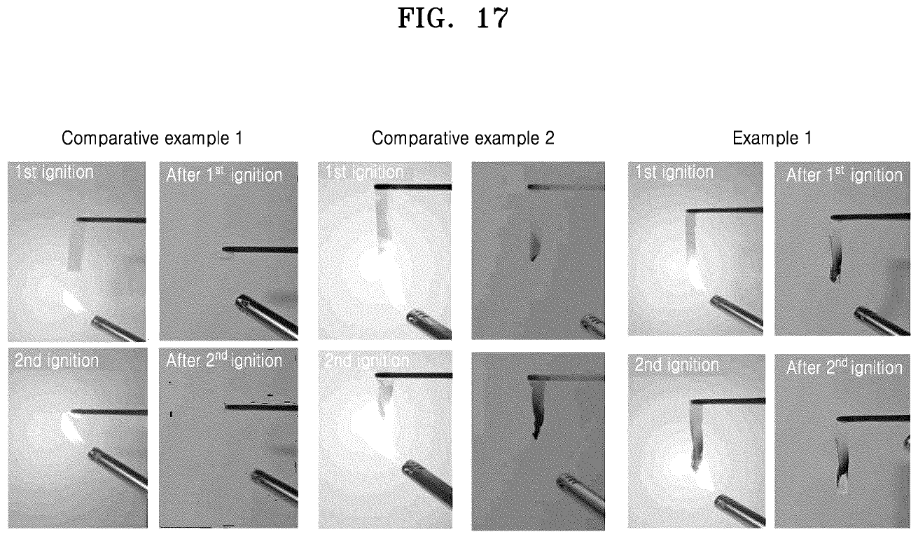

A rectangular specimen was brought into contact with flame and its shape was observed after 2 seconds. This process was repeated twice to evaluate flame retardancy. The evaluation results thereof are shown in FIG. 17.

As shown in FIG. 17, the separator of Comparative Example 1 was completely combusted upon first flame contact.

The separator of Comparative Example 2 was partially combusted after secondary flame contact, but was mostly self-extinguished.

The composite separator of Example 1 was not ignited even after secondary flame contact, and the second layer and the third layer were partially combusted, but the first layer was self-extinguished while maintaining its original form, thereby exhibiting excellent flame retardancy.

### Evaluation Example 6: Flame Retardancy Evaluation (II)

Flame retardancy was evaluated for the separator (Celgard) of Comparative Example 1, the separator (PVDF) of Comparative Example 2, and the composite separator (PVDF/LLZO/PVDF) prepared in Example 1.

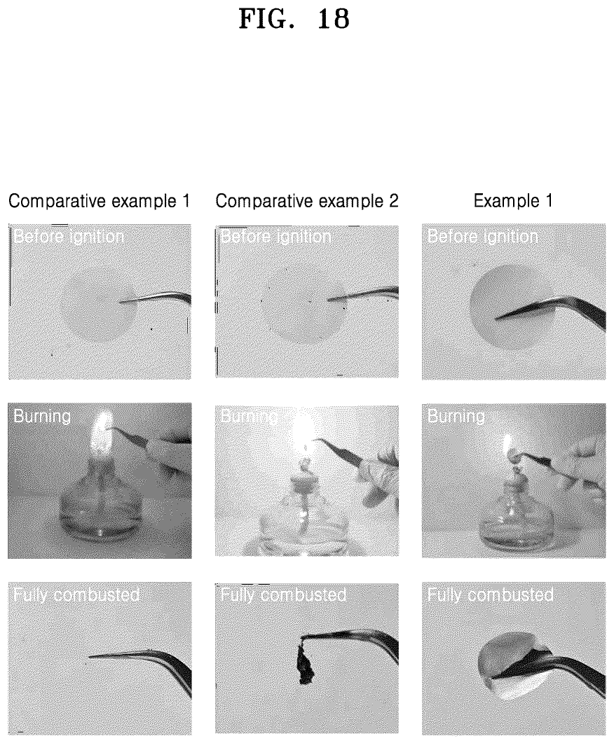

Flame retardancy was evaluated by observing the shape of a circular specimen after contacting the circular specimen with flame for 10 seconds or more. The evaluation results thereof are shown in FIG. 18.

As shown in FIG. 18, the separator of Comparative Example 1 was completely melted by contact with the flame.

The separator of Comparative Example 2 was completely combusted after contact with the flame.

The composite separator of Example 1 was not ignited even after contact with the flame, and the second layer and the third layer were partially combusted, but the first layer maintained its original form, thereby exhibiting excellent flame retardancy.

### Evaluation Example 7: Ionic Conductivity Measurement

Impedance was measured for the ion-conductive composite film (LLZO 50 wt %) of Comparative Preparation Example 1, the separator (Celgard) of Comparative Example 1, the composite separator (PVDF/LLZO) prepared in Comparative Example 3, the composite separator (LLZO/PVDF/LLZO) prepared in Comparative Example 4, and the composite separators (PVDF/LLZO/PVDF) prepared in Examples 1 and 2. The separators of Comparative Preparation Example 1, Comparative Example 1, Comparative Example 3, Comparative Example 4, Example 1, and Example 2 were impregnated with a liquid electrolyte, arranged between symmetrical cells of stainless steel electrodes, and then lithium ion transference numbers were measured using a DC polarization method. As the liquid electrolyte, a liquid electrolyte in which 1.0 M LiPF₆ is dissolved in a mixed solvent with a volume ratio of EC/EMC/DMC of 1:1:1 was used.

The time dependent current obtained when a constant voltage of 100 mV was applied to the symmetric cells for 4 hours was measured. Lithium ion transference number was calculated from the measured current using Equation 1 below.

$${t}_{+} = \frac{{I}_{ss} ( Δ V - {I}_{0} {R}_{int , O} )}{{I}_{0} ( Δ V - {I}_{ss} {R}_{i nt , ss} )} \qquad 〈 Equation 1 〉$$

in Equation 1,
Iₒ is an initial current, Iₛₛ is a steady state current, Rᵢₙₜ is an initial resistance, R_{int ss} is a steady state resistance, and ΔV is a polarization resistance setting value.

Impedance was measured before and after using the DC polarization method for the symmetric cells.

Impedance was measured by a 2-probe method using an impedance analyzer (Solartron 1560A/1455A impedance analyzer). The frequency range was 0.1 Hz to 32 MHz, and the amplitude voltage was 30 mV. Measurements were performed at 25° C. in an air atmosphere. Electrolyte resistance was obtained from the Nyquist plot of the impedance measurement results, and ionic conductivity was calculated from this electrolyte resistance.

The ionic conductivity and effective ionic conductivity were calculated from the impedance measurement results before and after using the DC polarization method and the lithium ion transference number, and some of the results are shown in Table 2 below.

TABLE 2

| | Ionic | Effective ionic | Lithium ion |
|---|---|---|---|
| | conductivity | conductivity | transference |
| | [mS/cm] | [mS/cm] | number |
| Comparative | 0.0027 | — | — |
| Preparation | | | |
| Example 1 | | | |
| Comparative | 0.46 | 0.21 | 0.46 |
| Example 1 | | | |
| Comparative | 0.11 | — | — |
| Example 3 | | | |
| Comparative | 0.10 | — | — |
| Example 4 | | | |
| Example 1 | 0.43 | 0.38 | 0.89 |
| Example 2 | 0.31 | 0.19 | 0.60 |

As shown in Table 2, the composite separators prepared in Examples 1 and 2 exhibited excellent ionic conductivity, effective ionic conductivity, and lithium ion transference number.

The commercially available separator of Comparative Example 1 had a lower lithium ion transference number than the composite separators prepared in Examples 1 and 2.

In comparison, the composite separators prepared in Examples 3 and 4 had significantly reduced ionic conductivity compared to the composite separators prepared in Examples 1 and 2.

The ion-conductive composite film of Comparative Preparation Example 1 had a significantly increased resistance and a significantly reduced ionic conductivity compared to the composite separators of Examples 1 and 2.

### Evaluation Example 8: Electrochemical Stability Evaluation (Linear Sweep Voltammetry, LSV)

Electrochemical stability was evaluated by linear sweep voltammetry for the separator (Celgard) of Comparative Example 1, the separator (PVDF) prepared in Comparative Example 2, and the composite separator (PVDF/LLZO/PVDF) of Example 1.

The separator of Comparative Example 1, the separator of Comparative Example 2, and the composite separator of Example 1 were impregnated with a liquid electrolyte, and then electrochemical stability was measured. As the liquid electrolyte, a liquid electrolyte in which 1.0 M LiPF₆ and 2 wt % of VC are dissolved in a mixed solvent with a volume ratio of EC/EMC of 3:7 was used.

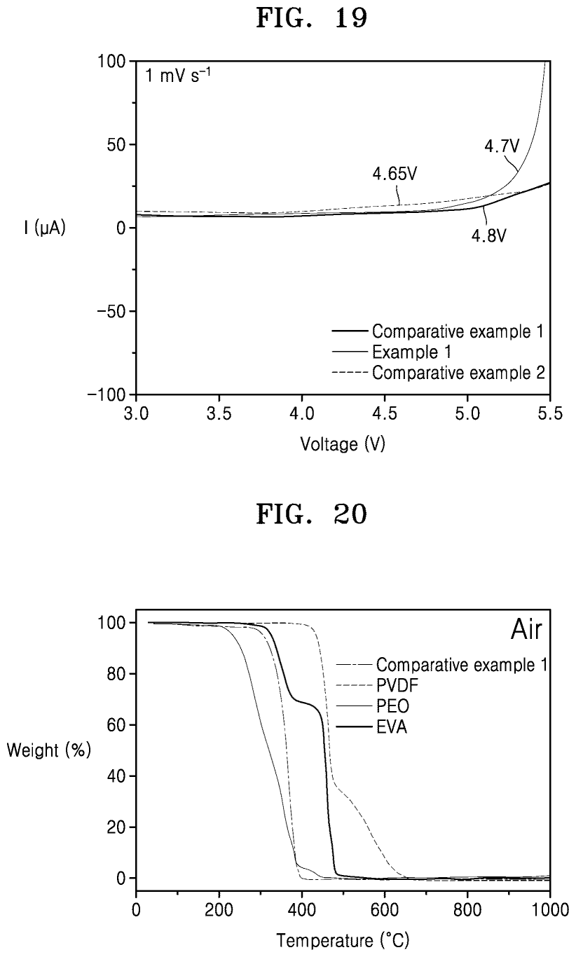

The separator (Celgard) of Comparative Example 1, the separator (PVDF) prepared in Comparative Example 2, and the composite separator (PVDF/LLZO/PVDF) of Example 1 were each disposed between symmetrical cells of lithium metal and stainless steel electrodes, and electrochemical stability was evaluated by measuring a current according to potential using linear sweep voltammetry in the voltage range of 0 to 6 V (vs. Li) at a scan rate of 1 mV/sec. The evaluation results thereof are shown in FIG. 19.

As shown in FIG. 19, the composite separator of Example 1 exhibited an onset potential of 4.7 V (vs. Li) or more. The composite separator of Example 1 exhibited a wide electrochemically stable voltage window of 4.7 V or more. In contrast, the separator of Comparative Example 2 exhibited an onset potential of 4.65 V.

### Evaluation Example 9: Evaluation of heat resistance of first polymer

Thermal decomposition temperature of the separator (Celgard), polyvinylidene fluoride (PVDF), polyethylene oxide (PEO) of Comparative Example 1, and ethylene-vinyl acetate (EVA) used in Preparation Example 7 was measured through thermogravimetric analysis.

The measurement results thereof are shown in FIG. 20.

As shown in FIG. 20, the thermal decomposition temperature of the separator (Celgard) of Comparative Example 1, polyvinylidene fluoride (PVDF), and ethylene-vinyl acetate (EVA) used in Preparation Example 7 was 350° C. or more.

In contrast, the thermal decomposition temperature of polyethylene oxide (PEO) was less than 350° C.

### Evaluation Example 10: Evaluation of Porosity and Electrolyte Uptake

Porosity and electrolyte uptake (i.e., electrolyte impregnation rate) were evaluated for the separator (Celgard) of Comparative Example 1, the separator (PVDF) prepared in Comparative Example 2, the ion-conductive composite film (LLZO-EVA) prepared in Preparation Example 7, and the composite separator (PVDF/LLZO/PVDF) prepared in Example 1. As the liquid electrolyte, a liquid electrolyte in which 1.0 M LiPF₆ and 2 wt % of VC are dissolved in a mixed solvent with a volume ratio of EC/EMC of 3:7 was used.

The porosity was measured using a liquid displacement method. The electrolyte impregnation rate was measured using a liquid displacement method.

Porosity was calculated from Equation A.

$$Porosity ( \% ) = {W}_{I} / {ρ}_{I} / ( WI / {ρ}_{I} + {W}_{s} / {ρ}_{s} ) \times 100 \qquad 〈 Equation A 〉$$

Wₗ is a weight of 1-butanol, Wₛ is a weight of a dry separator, ρₗ is a density of 1-butanol, and ρₛ is a density of a separator.

Electrolyte uptake was calculated from Equation B.

$$Electrolyte uptake ( \% ) = ( {W}_{wet} - {W}_{dry} ) / {W}_{dry} \times 100 \qquad 〈 Equation B 〉$$

W_{wet} is a weight of a separator impregnated with an electrolyte, and W_{dry} is a weight of a dry separator.

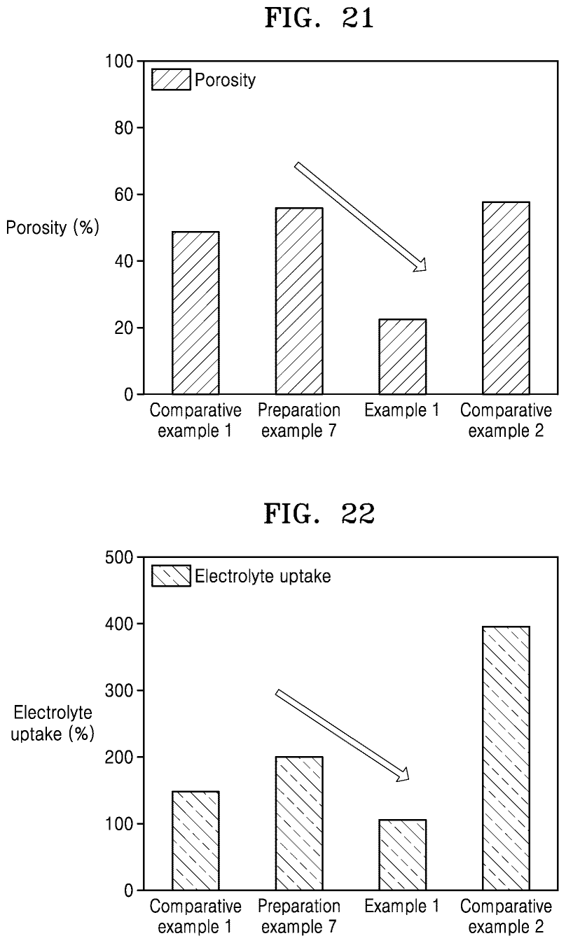

The measurement results thereof are shown in FIGS. 21 and 22, respectively.

As shown in FIG. 21, the composite separator of Example 1 exhibited a low porosity of 25% or less.

As shown in FIG. 22, the composite separator of Example 1 exhibited a low electrolyte uptake of 120% or less.

### Evaluation Example 11: Evaluation of Critical Current and Lifespan Characteristics

Critical current density and lifespan characteristics were measured for symmetrical cells including the separator (Celgard) of Comparative Example 1, the separator (PVDF) prepared in Comparative Example 2, the ion-conductive composite film (LLZO-EVA) prepared in Preparation Example 7, and the composite separator (PVDF/LLZO/PVDF) prepared in Example 1.

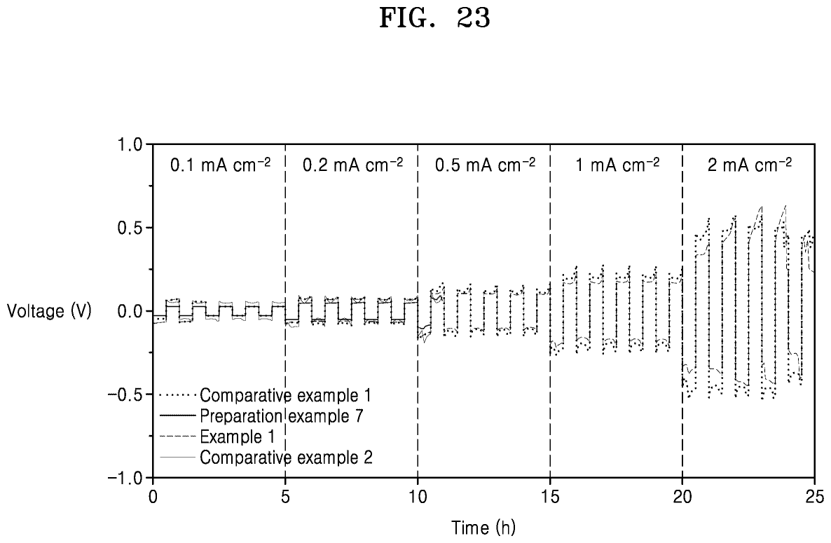

The separators of Comparative Example 1, Comparative Example 2, Preparation Example 7, and Example 1 were impregnated with a liquid electrolyte, arranged between lithium metal symmetrical cells, and then critical current was measured while charging and discharging the symmetrical cells at a constant current of 0.1 mA/cm², 0.2 mA/cm², 0.5 mA/cm², 1 mA/cm², and 2 mA/cm². The measurement results thereof are shown in FIG. 23.

As shown in FIG. 23, the composite separator of Example 1 operated stably up to 2 mA/cm², but the separator of Comparative Example 2 and the ion-conductive composite film of Preparation Example 7 short-circuited at 0.5 mA/cm².

It was shown that the composite separator of Example 1, in which the porous layer of Comparative Example 2 was additionally formed on both surface of the ion-conductive composite film of Preparation Example 7, has an increased critical current density.

It was found that the composite separator of Example 1 provides improved electrochemical stability compared to the ion-conductive composite film of Preparation Example 7 and the separator of Comparative Example 2.

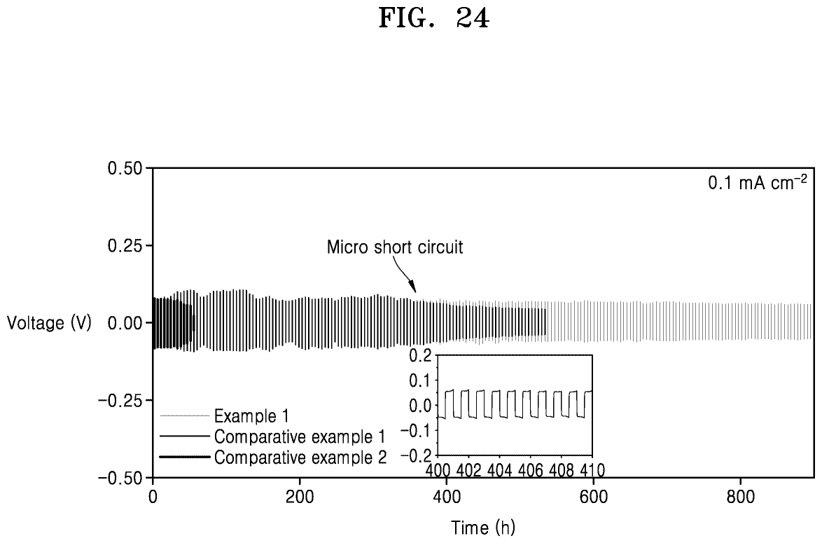

The separators of Comparative Example 1, Comparative Example 2, and Example 1 were impregnated with a liquid electrolyte, arranged between lithium metal symmetrical cells, and then lifespan characteristics were measured while charging and discharging the symmetrical cells at a constant current of 0.1 mA/cm². The measurement results thereof are shown in FIG. 24.

As shown in FIG. 24, the composite separator of Example 1 exhibited improved lifespan characteristics with a significantly increased short-circuit occurrence time compared to the separators of Comparative Examples 1 and 2.

### (Manufacture of Lithium Battery (Half Cell))

### Example 3

### (Manufacture of Cathode)

A commercially available cathode including LiNi_{0.8}Co_{0.1}Mn_{0.1}O₂ as a cathode active material, and including a cathode active material, a conductive material, and a binder at a weight ratio of 90:5:5 was used.

### (Manufacture of Lithium Battery)

Lithium metal foil was used as an anode.

The composite separator prepared in Example 1 was disposed between the manufactured cathode and anode to prepare a laminate. An ion-conductive composite film of the composite separator is disposed adjacent to the anode.

A liquid electrolyte was injected into the laminate, and this laminate was sealed to prepare a half cell. As the liquid electrolyte, a liquid electrolyte, in which 1.0 M LiPF₆ and 2 wt % vinylene carbonate (VC) are dissolved in a mixed solvent with a volume ratio of EC/EMC of 3:7, was used.

### Comparative Example 6

A lithium battery was manufactured in the same manner as in Example 3, except that the commercially available separator of Comparative Example 1 was used instead of the composite separator prepared in Example 1.

### Comparative Example 7

A lithium battery was manufactured in the same manner as in Example 3, except that the composite separator of Comparative Example 5 was used instead of the composite separator prepared in Example 1.

### Evaluation Example 12: Charge/Discharge Test (I)

Charge/discharge tests were performed at room temperature (25° C.) for the lithium batteries of Example 3 and Comparative Examples 6 and 7 under the following conditions.

The lithium battery was charged at a constant current of 0.5 C rate until a voltage reached 4.3 V (vs. Li). Subsequently, the lithium battery was discharged at a constant current of 0.5 C rate until the battery voltage reached 2.7 V (vs. Li).

This charge/discharge cycle was repeated 500 times. Some of the results of the charge/discharge test at room temperature are shown in FIG. 25 and Table 3.

In FIG. 25, the left y-axis is a discharge capacity and the right y-axis is a charge/discharge efficiency.

The capacity retention rate is defined by Equation 2 below. The charge/discharge efficiency is defined by Equation 3 below.

$$Capacity retention rate [ \% ] = [ discharge capacity at {500}^{th} cycle / discharge capacity at {1}^{st} cycle ] \times 100 \qquad 〈 Equation 2 〉$$

$$Charge / discharge efficiency [ \% ] = [ discharge capacity at {n}^{th} cycle / charge capacity at {n}^{th} cycle ] \times 100 \qquad 〈 Equation 3 〉$$

TABLE 3

| | Capacity retention rate |
|---|---|
| | [%] |
| Example 3 | 62 |
| Comparative | 0 |
| Example 6 | |

As shown in Table 3 and FIG. 25, the lithium battery of Example 3 exhibited significantly improved lifespan characteristics and charge/discharge efficiency compared to the lithium battery of Comparative Example 6.

Although not shown in Table, the lithium battery of Comparative Example 7 also had poor charge/discharge characteristics compared to the lithium battery of Example 3.

### (Manufacture of Lithium Battery (Full Cell))

### Example 4

### (Manufacture of Cathode)

LiFePO₄ (MTI corporation) powder and a carbon conductive material (Super-P; Timcal Ltd.) was uniformly mixed at a weight ratio of 80:10, and then a polyvinylidene fluoride (PVDF) binder solution was added to prepare a cathode active material slurry with a weight ratio of active material:carbon-based conductive material:binder=80:10:10. The prepared cathode active material slurry was applied onto an aluminum current collector using a doctor blade, dried, and then rolled into a sheet using a roll press to manufacture a cathode.

### (Manufacture of Anode)

80 wt % of graphite powder (artificial graphite, MTI Corporation) as an anode active material, 10 wt % of carbon conductive material (Super-P; Timcal Ltd.), and 10 wt % of polyvinylidene fluoride (PVDF) as a binder was mixed, added to an N-methyl-2-pyrrolidone solvent, and then stirred to prepare an anode active material slurry. The prepared anode active material slurry was applied onto a copper foil current collector using a doctor blade, dried, and then rolled into a sheet using a roll press to manufacture an anode.

### (Manufacture of Lithium Battery)

The composite separator prepared in Example 1 was disposed between the manufactured cathode and anode to prepare a laminate. An ion-conductive composite film of the composite separator is disposed adjacent to the anode.

A liquid electrolyte was injected into the laminate, and this laminate was sealed to prepare a full cell. As the liquid electrolyte, a liquid electrolyte, in which 1.0 M LiPF₆ and 2 wt % vinylene carbonate (VC) are dissolved in a mixed solvent with a volume ratio of EC/EMC of 3:7, was used.

### Evaluation Example 13: Charge/Discharge Test (II)

A charge/discharge test was performed at room temperature (25° C.) for the lithium battery of Example 4 under the following conditions.

The lithium battery was charged at a constant current of 0.1 C rate until a voltage reached 4.0 V (vs. Li). Subsequently, the lithium battery was discharged at a constant current of 0.1 C rate until the battery voltage reached 2.25 V (vs. Li).

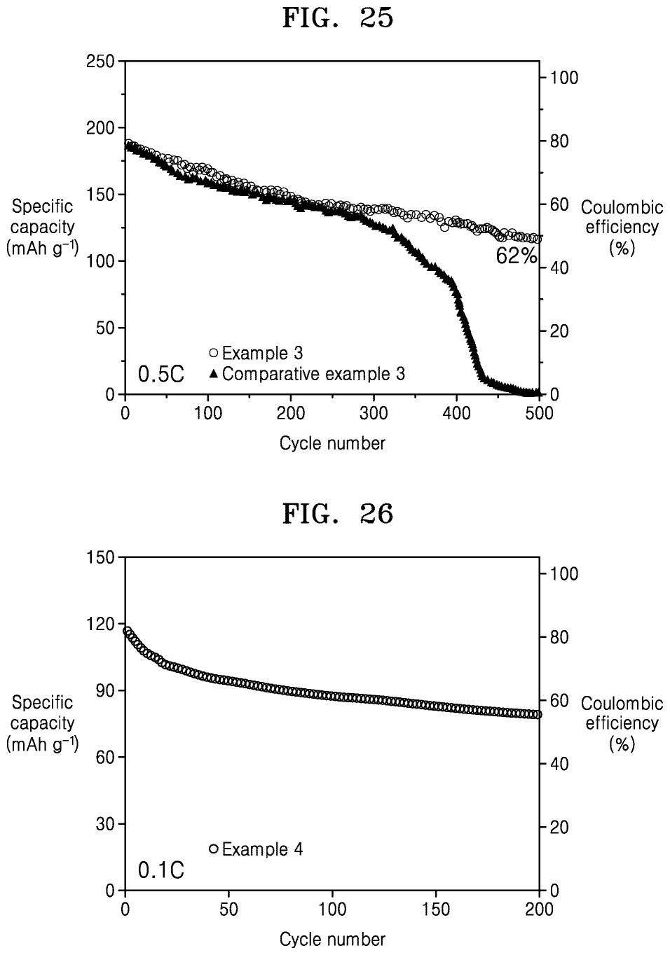

This charge-discharge cycle was repeated 200 times. The results of the charge/discharge test at room temperature are shown in FIG. 26.

In FIG. 26, the left y-axis is a discharge capacity and the right y-axis is a charge/discharge efficiency.

The charge/discharge efficiency is defined by Equation 4 below.

$$Charge / discharge efficiency [ \% ] = [ discharge capacity at {n}^{th} cycle / charge capacity at {n}^{th} cycle ] \times 100 \qquad 〈 Equation 4 〉$$

As shown in FIG. 26, the lithium battery of Example 4 exhibited excellent discharge capacity and charge/discharge efficiency.

According to one aspect, it is possible to provide a composite separator having reduced interfacial resistance, improved mechanical properties, improved heat resistance, and improved flame retardancy by including an ion-conductive composite layer including a high content of an oxide-based solid electrolyte and a carbonyl group-containing polymer, and a polymer layer disposed on each surface of the ion-conductive composite layer.

According to another aspect, it is possible to provide a composite electrolyte having reduced interfacial resistance and improved electrochemical stability by having the above-described composite separator.

According to another aspect, it is possible to provide a lithium battery having improved heat resistance, improved flame retardancy, and improved lifespan characteristics by having the above-described composite separator.

Although exemplary embodiments have been described in detail with reference to the attached drawings, the present inventive concept is not limited thereto. It is obvious that a person with ordinary knowledge in the technical field to which the present inventive concept belongs can derive various examples of changes or modifications within the scope of the technical idea described in the patent claims, and these also naturally belong to the technical scope of the present inventive concept.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A composite separator comprising: a first layer including an oxide-based solid electrolyte and a carbonyl group-containing first polymer;
a second layer disposed on one surface of the first layer and including a second polymer; and
a third layer disposed on the other surface of the first layer and including a third polymer,
wherein a content of the oxide-based solid electrolyte is 80 wt % or more with respect to a total weight of the oxide-based solid electrolyte and the first polymer.

2. The composite separator of claim 1,
wherein the oxide-based solid electrolyte includes an oxide-based solid electrolyte core and a coating layer disposed on a surface of the core,
the coating layer includes a lithium-containing compound, and
the lithium-containing compound includes lithium carbonate, lithium hydroxide, or a combination thereof.

3. The composite separator of claim 2,
wherein the coating layer is disposed between the oxide-based solid electrolyte core and the first polymer, and
the coating layer is a conformal coating layer disposed along a contour of the surface of the oxide-based solid electrolyte core.

4. The composite separator of claim 2,
wherein, in XPS depth profile measurement of the surface of the oxide-based solid electrolyte,
a second oxygen peak derived from lattice oxygen (O_{lattice}) of the oxide-based solid electrolyte at about 527.5 eV to about 530 eV is absent when sputtering begins, and
a ratio (P2/P1) of an intensity (P1) of a first oxygen peak derived from lithium carbonate (Li₂CO₃) at a binding energy of about 530 eV to about 532.5 eV and an intensity (P2) of the second oxygen peak derived from lattice oxygen (O_{lattice}) of the oxide-based solid electrolyte at a binding energy of about 527.5 eV to about 530 eV is 1 or less at 130 seconds after sputtering begins.

5. The composite separator of claim 2,
wherein the coating layer has a thickness of about 3 nm to about 100 nm.

6. The composite separator of claim 1,
wherein the oxide-based solid electrolyte is an oxide or phosphate including lithium and two or more metals other than lithium,
the oxide-based solid electrolyte includes a Garnet-type solid electrolyte, a Nasicon-type solid electrolyte, a LISICON-type solid electrolyte, a perovskite-type solid electrolyte, a LiPON-type solid electrolyte, an amorphous solid electrolyte, or a combination thereof,
the oxide-based solid electrolyte includes a lithium-lanthanum-zirconium-oxide (LLZO), a lithium-aluminum-titanium-phosphate (LATP), a lithium-lanthanum-titanium-oxide (LLTO), a lithium-aluminum-germanium-phosphate (LAGP), or a combination thereof, and
a content of lithium per mol of the lithium-lanthanum-zirconium-oxide is 6.8 mol or more.

7. The composite separator of claim 1,
wherein the oxide-based solid electrolyte includes a garnet-type oxide,
the garnet-type oxide includes a cubic phase, and
the garnet-type oxide is represented by Formula 1 below: 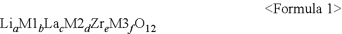
wherein in Formula 1,
M1 is H, Fe, Ga, Al, B, Be, or a combination thereof,
M2 is Ba, Ca, Sr, Y, Bi, Pr, Nd, Ac, Sm, Gd, or a combination thereof,
M3 is Al, Ga, Ta, Nb, Hf, Ti, V, Cr, Co, Ni, Cu, Mo, W, Mg, Tc, Pd, Sc, Cd, In, Sb, Te, TI, Pt, Si, Ir, Ru, Mn, Sn, or a combination thereof, and
6≤a≤8, 0≤b≤2, 2.5≤c≤3.5, 0≤d≤0.2, 1.5≤e≤2.5, and 0≤f≤1.

8. The composite separator of claim 1,
wherein the first polymer includes an ester group-containing polymer, an amide group-containing polymer, or a combination thereof, and
the first polymer is a non-fluorinated polymer.

9. The composite separator of claim 1,
wherein the first polymer includes an acetate polymer, an acrylic polymer, a urethane polymer, or a combination thereof, and
the first polymer includes ethylene-vinyl acetate (EVA), polyvinyl acetate (PVAc), polyurethane (PU), polymethyl methacrylate (PMMA), polyethylene terephthalate (PET), or a combination thereof.

10. The composite separator of claim 1,
wherein the first polymer has a thermal decomposition temperature of 300° C. or higher during TGA thermal analysis.

11. The composite separator of claim 1,
wherein the first layer includes an ion-conductive composite film,
the ion-conductive film is a free-standing film, and
the composite separator is a stretchable free-standing film or a flexible free-standing film.

12. The composite separator of claim 1,
wherein the second layer and the third layer are each independently a porous layer,
the second polymer and the third polymer each independently include a fluorine-based polymer, and
the fluorine-based polymer includes polyvinylidene fluoride (PVDF), a polyvinylidene fluoride-hexafluoropropylene copolymer (PVDF-HFP), polytetrafluoroethylene (PTFE), or a combination thereof.

13. The composite separator of claim 1,
wherein the second layer and the third layer are each independently an organic layer, and
the second layer and the third layer are free of inorganic particles.

14. The composite separator of claim 1,
wherein a ratio (T2/T1) of a thickness (T2) of the second layer to a thickness (T1) of the first layer is about 0.01 to about 100,
a ratio (T3/T1) of a thickness of the third layer (T3) to a thickness of the first layer (T1) is about 0.01 to about 100,
the first layer has a thickness of about 10 μm to about 100 μm, and
the second layer or the third layer has a thickness of about 1 μm to about 100 μm.

15. The composite separator of claim 1,
wherein the first layer has a porosity of less than 30%,
the second layer or the third layer has a porosity of more than 30%,
the composite separator has a porosity of 40% or less, and
the composite separator has an electrolyte uptake of 130% or less.

16. The composite separator of claim 1,
wherein the composite separator has an ionic conductivity of 0.2 mS/cm or more at 25° C. and 1 atm,
the composite separator has an effective ionic conductivity of 0.25 mS/cm or more at 25° C. and 1 atm,
the composite separator has a lithium ion transference number of 0.5 or more, and
the composite separator has an electrochemical stability voltage window of 4.7 V (vs. Li) or more and has an oxidation current of 10 μA or less.

17. The composite separator of claim 1,
wherein the composite separator has a thermal shrinkage rate of 3% or less after exposure at 180° C. for 20 minutes.

18. The composite separator of claim 1,
wherein the composite separator is self-extinguishing.

19. A composite electrolyte comprising: the composite separator of claim 1; and
an electrolyte disposed in the composite separator.

20. A lithium battery comprising: a cathode; an anode; and the composite separator of claim 1 between the cathode and the anode.
